(19) United States
(12) Patent Application Publication
(10) Pub. No.: US 2016/0378900 A1
(43) Pub. Date: Dec. 29, 2016

(54) NON-TRANSITORY COMPUTER-READABLE STORAGE MEDIUM, CIRCUIT DESIGN SUPPORT METHOD, AND INFORMATION PROCESSING DEVICE

(71) Applicant: FUJITSU LIMITED, Kawasaki-shi (JP)

(72) Inventors: Ryoko OKUBO, Kawasaki (JP); Mitsuru Sato, Kawasaki (JP); Kazunori Kumagai, Yokohama (JP)

(73) Assignee: FUJITSU LIMITED, Kawasaki-shi (JP)

(21) Appl. No.: 15/187,183

(22) Filed: Jun. 20, 2016

(30) Foreign Application Priority Data
Jun. 24, 2015 (JP) 2015-126915

(51) Int. Cl. G06F 17/50

(52) U.S. Cl. CPC G06F 17/5072

(57) ABSTRACT

A non-transitory computer-readable storage medium storing a circuit design support program that causes a computer to execute a process including generating topology data indicating wiring states of components in a circuit to be designed based on circuit data, the topology data including at least one coupling line between each pair of nodes including at least one first node and at least one second node, each of the at least one first node corresponding to each of the components and each of the at least one second node corresponding to each of at least one branch point in a wiring of the circuit when the wiring includes the at least one branch point, and displaying the generated topology data and an input field for receiving an input of restrictive data indicating restrictive requirements for each of the at least one coupling line between each of the nodes.

### CROSS-REFERENCE TO RELATED APPLICATION

This application is based upon and claims the benefit of priority of the prior Japanese Patent Application No. 2015-126915, filed on Jun. 24, 2015, the entire contents of which are incorporated herein by reference.

### FIELD

The embodiment discussed herein is related to a non-transitory computer-readable storage medium, a circuit design support method, and an information processing device.

### BACKGROUND

Traditionally, in the development of printing boards, tasks are conducted through stages such as specification design, circuit design, implementation design, analysis, board prototyping, and manufacturing. In the circuit design, a designer connects multiple components, a power source, a ground, and the like by connection lines in order to achieve functions of a system to be designed. The connection lines are referred to as nets. In the circuit design, the designer sets restrictive requirements for the nets of a circuit and gaps between pins of the circuit after designing the circuit.

For example, for the design of a semiconductor integrated circuit, a technique for entering restrictive values such as the sizes of transistors and generating template data is known.

In addition, for example, for the generation of a photomask for a semiconductor integrated circuit, a technique for entering parameters in existing template data and generating new template data is known.

In addition, for example, the following technique is known: a technique for extracting, from a circuit to be designed and implemented, a partial circuit that is the same as or similar to template data to which a restrictive requirement is added and applying, to the extracted circuit, the restrictive requirement added to the template data.

### SUMMARY

According to an aspect of the invention, A non-transitory computer-readable storage medium storing a circuit design support program that causes a computer to execute a process including generating topology data indicating wiring states of components in a circuit to be designed based on circuit data indicating components included in the circuit and coupling relationships between the components, the topology data including at least one coupling line between each pair of nodes including at least one first node and at least one second node, each of the at least one first node corresponding to each of the components and each of the at least one second node corresponding to each of at least one branch point in a wiring of the circuit when the wiring includes the at least one branch point, and displaying, in a display area, the generated topology data and an input field for receiving an input of restrictive data indicating restrictive requirements for each of the at least one coupling line between each of the nodes including the at least one first node and the at least one second node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of operations of an information processing device according to an embodiment;

FIG. 2 is an explanatory diagram illustrating an example of a design flow;

FIG. 3 is an explanatory diagram illustrating an example in which restrictive requirements are transmitted and received;

FIG. 4 is an explanatory diagram illustrating an example of an instruction to arrange components in accordance with a restrictive requirement;

FIG. 5 is an explanatory diagram illustrating an example of an instruction for a wiring length of a net in accordance with a restrictive requirement;

FIG. 6 is an explanatory diagram illustrating an exemplary circuit;

FIGS. 7A and 7B are explanatory diagrams illustrating examples of restrictive requirements specified for the exemplary circuit illustrated in FIG. 6;

FIG. 8 is an explanatory diagram illustrating an example of a restrictive requirement entered based on a topology displayed on a GUI;

FIG. 9 is an explanatory diagram illustrating an example in which restrictive requirements are converted into templates;

FIG. 10 is a block diagram illustrating an example of a hardware configuration of the information processing device;

FIG. 11 is a block diagram illustrating an example of a functional configuration of the information processing device;

FIG. 12 is an explanatory diagram illustrating an example of a circuit database;

FIG. 13 is an explanatory diagram illustrating an exemplary circuit;

FIG. 14 is an explanatory diagram illustrating an example of a circuit database indicating the exemplary circuit illustrated in FIG. 13;

FIG. 15 is an explanatory diagram illustrating an example of net tables;

FIG. 16 is an explanatory diagram illustrating an example of component tables;

FIG. 17 is an explanatory diagram illustrating an example of component pin tables;

FIG. 18 is an explanatory diagram illustrating an example of a restrictive requirement table;

FIG. 19 is an explanatory diagram illustrating example of topology data;

FIG. 20 is an explanatory diagram illustrating an example of an image of a topology;

FIG. 21 is an explanatory diagram illustrating an example of line length data;

FIG. 22 is an explanatory diagram illustrating an example of path definition data;

FIG. 23 is an explanatory diagram illustrating an example of template data;

FIG. 24 is an explanatory diagram illustrating an example of selection;

FIG. 25 is an explanatory diagram illustrating an example of a selected element table;

FIG. 26 is an explanatory diagram illustrating an example of a circuit and path trace DB;

FIG. 27 is an explanatory diagram illustrating an example of a circuit to be used to generate topology data;

FIG. 28 is an explanatory diagram illustrating an example of a symbol database;

FIG. 29 is an explanatory diagram illustrating an example in which symbols of components are arranged on a topology diagram;

FIG. 30 is an explanatory diagram illustrating an example of the determination of distances between columns;

FIG. 31 is an explanatory diagram illustrating an example of symbol definition data and node definition data;

FIG. 32 is an explanatory diagram illustrating an example of the generation of path definition data;

FIG. 33 is an explanatory diagram illustrating an example of display;

FIG. 34 is a flowchart of an example of a procedure for a circuit design support process by the information processing device;

FIG. 35 is a flowchart of details of a trace process illustrated in FIG. 34;

FIG. 36 is a flowchart of details of a topology data generation process illustrated in FIG. 34;

FIG. 37 is a first flowchart of details of a path definition data generation process illustrated in FIG. 34; and

FIG. 38 is a second flowchart of details of the path definition data generation process illustrated in FIG. 34.

### DESCRIPTION OF EMBODIMENT

In the aforementioned circuit design, however, it is difficult for the designer to imagine a topology for the designed circuit and set a restrictive requirement for a complex path.

According to an aspect, an object of an embodiment is to enable a designer to set restrictive requirements while looking at an image of a topology on a screen.

Hereinafter, a circuit design support program, circuit design support method, and information processing device according to the embodiment are described with reference to the accompanying drawings.

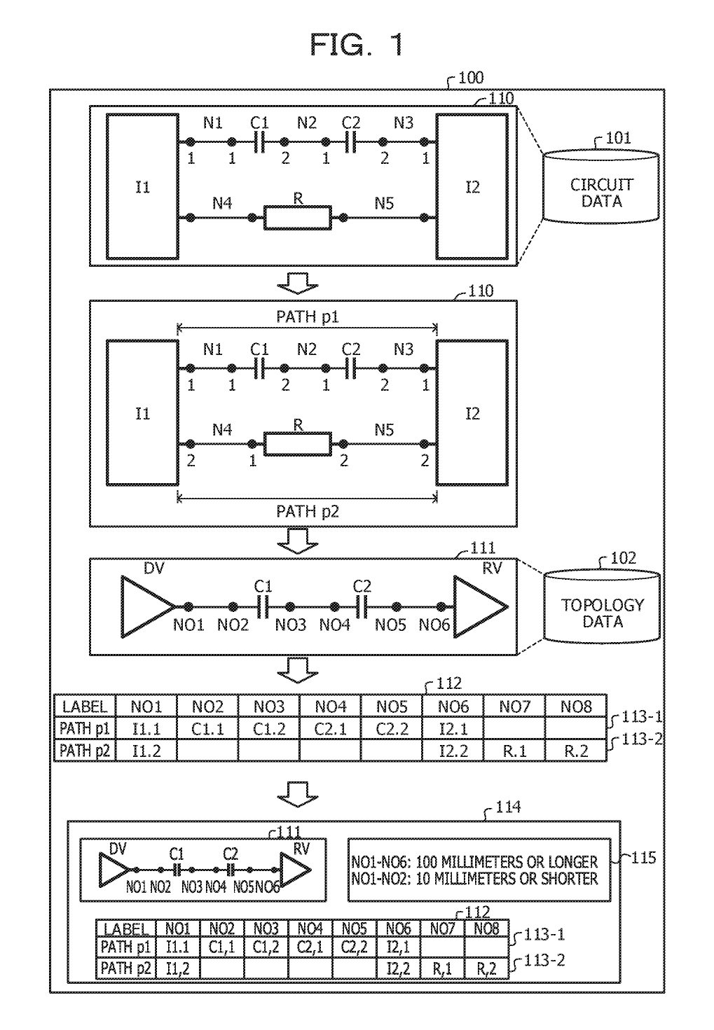

FIG. 1 is an explanatory diagram illustrating an example of operations of the information processing device according to the embodiment. An information processing device 100 is a computer configured to support the design of a circuit 110 by facilitating the setting of restrictive requirements for wirings of the circuit 110. The information processing device 100 achieves the circuit design support method by executing the circuit design support program.

Traditionally, for example, restrictive requirements are set by acquiring the names of component pins and the names of paths based on circuit data so as to cause the acquired names to be included in table data or the like and specifying, by a user, distances between the component pins and the lengths of the paths on the table data in some cases. For example, a single net is assigned to a single connection line connecting a pin of a driving component to a resistor. Thus, for example, if a net that extends from a pin of a first component to a pin of a second component is branched and connected to a pin of a third component, a restrictive requirement for a net portion extending from the pin of the first component to the pin of the second component and a restrictive requirement for a net portion extending from the pin of the first component to the pin of the third component are the same and set. As described above, traditionally, there has been a problem that, even if a net is branched, a detailed restrictive requirement is not set.

In the embodiment, association data that indicates association relationships between component pins on each path and nodes indicated by topology data is generated for each path for which a requirement is to be set and the association data, the topology data, and a requirement entry field are displayed. Thus, a circuit designer may set restrictive requirements while looking at a topology diagram on a screen.

An example in which a net that connects a pint of a first component to a pin of a second component is branched and connected to a pin of a third component is described below. In this example, a restrictive requirement for a net portion extending from the pin of the first component to the pin of the second component and a restrictive requirement for a net portion extending from the pin of the first component to the pin of the third component may be different from each other and set.

An implementation designer receives, from the circuit designer, the restrictive requirements associated to a topology. It is, therefore, possible to suppress the fact that the implementation designer arranges a wiring based on a topology that is not intended by the circuit designer.

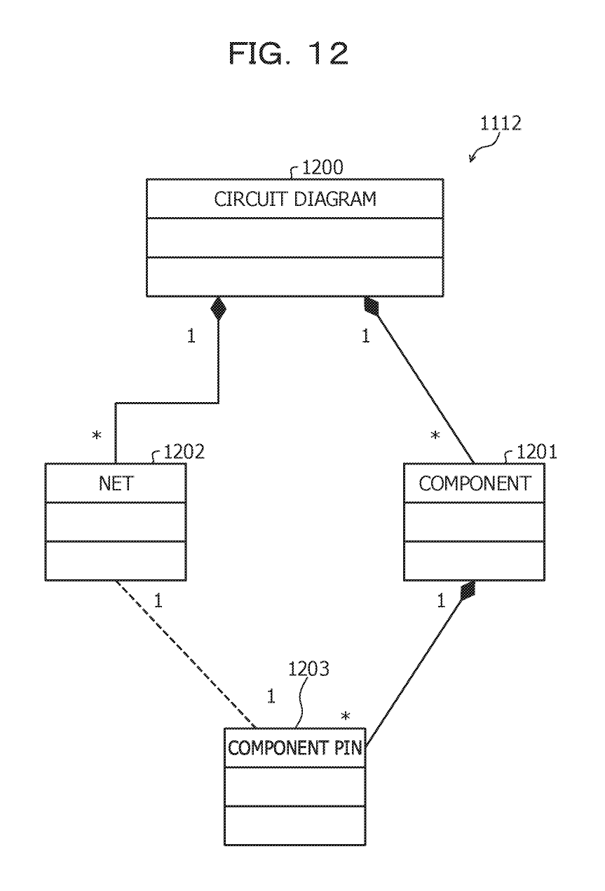

The information processing device 100 searches paths including selected elements included in the circuit 110 based on components included in the circuit 110 to be designed and circuit data 101 indicating connection relationships between the components included in the circuit 110 to be designed. The elements are components, connection lines, and the like. The connection lines are also referred to as nets, for example. The circuit data 101 is a net list, for example. The circuit data 101 is a circuit database illustrated in FIG. 12 and described later. The paths are routes extending from a terminal of a driving component to a terminal of a receiving component. The driving component is also referred to as a driver. The receiving component is also referred to as a receiver.

In the example illustrated in FIG. 1, the circuit 110 includes a component I1, a component I2, a component R, a component C1, and a component C2. The component I1 is the driver, for example. The component I2 is the receiver, for example. The component R is a resistor, for example. The component C1 and the component C2 are capacitors, for example. In the example illustrated in FIG. 1, the circuit 110 includes five nets N1 to N5, for example.

The selected elements are elements selected from the circuit 110 by a circuit designer's operation executed on the information processing device 100. In the example illustrated in FIG. 1, the nets N1 to N5 and the component R are the selected elements.

If the selected elements are nets, the information processing device 100 searches paths by tracing component pins connected to the nets or the like based on the circuit data 101, for example. The information processing device 100 may identify components and connection lines on the paths by searching the paths. In the example illustrated in FIG. 1, a path p1 and a path p2 are searched. For example, the number of the searched paths is two or more, driving components of the searched paths are the same, and at least receiving components of the searched paths among all receiving components of the searched paths are the same.

Next, the information processing device 100 generates, for a path that is among the searched paths and satisfies a predetermined requirement, topology data 102 indicating a wiring state of the path by using figures corresponding to identified components, nodes corresponding to terminals of the identified components, and nodes corresponding to branch points of identified connection lines. The wiring state is also referred to as a topology. The figures are also referred to as symbols. The symbols are figures indicating the components on a topology diagram. Symbol information is prepared for each component type. The symbols are arranged on the topology diagram based on the symbol information. The path that satisfies the predetermined requirement is a path of which the number of identified components is the largest among the searched paths, for example. In the example illustrated in FIG. 1, a topology 111 includes nodes NO1 to NO6.

Then, the information processing device 100 generates, for each of the searched paths, association data 113 indicating association relationships between terminals of identified components included in the searched path and nodes of a topology indicated by generated topology data 102. Path definition data 112 stores association data 113 for each of the paths.

Specifically, the information processing device 100 associates the names of nodes to labels of the path definition data 112, for example. Then, the information processing device 100 associates, for each of the paths p1 and p2, nodes of a topology with component pins of components on the path, for example.

The information processing device 100 associates a component pin I1.1 of the component I1 on the path p1 with the node NO1, for example. The information processing device 100 associates a component pin C1.1 of the component C1 on the path p1 with the node NO2, for example. Association data 113 associated for the path p1 is association data 113-1, while association data 113 associated for the path p2 is association data 113-2.

For example, since the information processing device 100 uses, for the path p1, the component pins of the components on the path p1 upon the generation of the topology data 102, the information processing device 100 may associate nodes to the pins of all the components on the path p1. For example, since a node corresponding to the component pin R.1 of the component R located on the path p2 and a node corresponding to the component pin R.2 of the component R located on the path p2 do not exist, the information processing device 100 adds nodes N07 and N08 to the path definition data 112 and associates the nodes N07 and N08 with the component pins R.1 and R.2 for the path p2.

Then, the information processing device 100 displays the topology data 102, the association data 113 generated for the searched paths, and an entry field 115 for receiving restrictive data indicating restrictive requirements for the searched paths. The restrictive data is distances between the nodes and is line length data described later, for example. The information processing device 100 generates an image 114 including the topology 111 indicated by the topology data 102, the association data 113, and the entry field 115 and displays the generated image, for example.

Since components pins on each of different paths extending from the same driver to the same receiver are associated with nodes, restrictive requirements may be set in detail using the nodes. Thus, the designer may set restrictive requirements while looking at the image of the topology 111 on the screen.

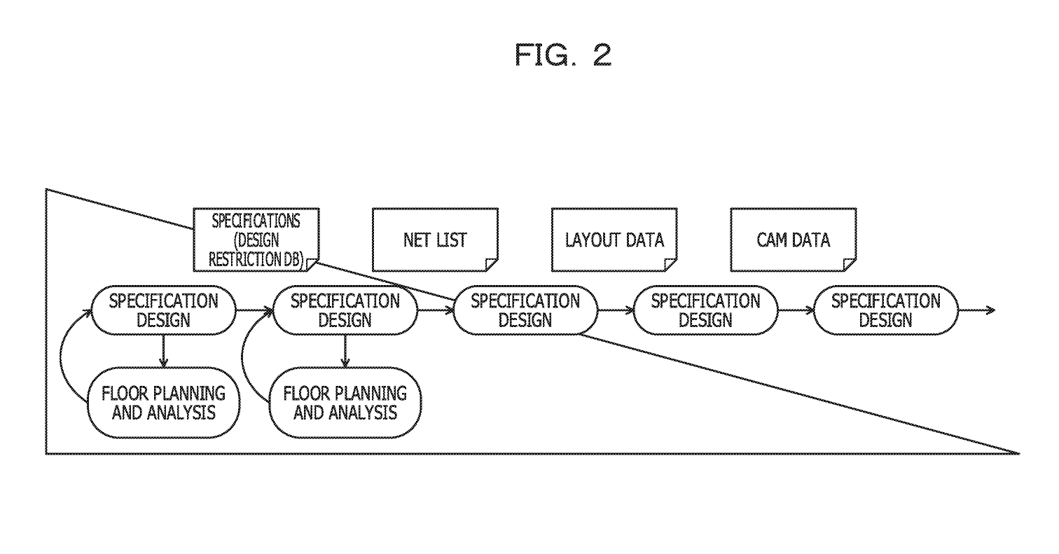

FIG. 2 is an explanatory diagram illustrating an example of a design flow. In order to facilitate understanding, a design flow for board design is described below. In the design flow, tasks are conducted in the order of specification design, circuit design, implementation design, analysis, and board prototyping.

In the specification design, the designer determines specifications such as system requirements for a circuit board and manufacturing requirements for the circuit board, for example. The system requirements are, for example, functions of a circuit to be designed, component configurations, an operational frequency, a bus configuration, and the like. The manufacturing requirements are, for example, a limit on arrangement, the number of layers, and the like. In the specification design, a specification document is created. The specification document indicates specifications determined in the specification design.

In floor planning and analysis in the specification design, the designer examines and creates restriction requirements for the circuit design and implementation design that do not cause a problem upon the manufacturing of a printing board.

Next, in the circuit design, in order to achieve the functions of the circuit to be designed, the designer conducts a task of connecting multiple components, a power source, and a ground by connection lines that are called nets. The designer creates restrictive requirements in some cases. In the circuit design, a net list is generated. In floor planning and analysis in the circuit design, the designer examines and creates restriction requirements for the circuit design and implementation design that do not cause a problem upon the manufacturing of the printing board.

In the circuit design, restrictive requirements for the implementation design are set in some cases. The restrictive requirements are stored in a restrictive requirement DB or the like. The restrictive requirements for the implementation design are the positions of components, wiring lengths of nets, intervals between wirings, the number of bypass capacitors, and the like.

In the implementation design, a task of arranging components to be included in the target circuit and a task of arranging wirings between the components are conducted in a simulation space so as to comply with connection requirements for the components to be included in the circuit indicated by the net list generated in the circuit design and restrictive requirements included in the restrictive requirement DB. In the implementation design, layout data is generated. The simulation space is a virtual space simulated on the computer. Specifically, the simulation space is, for example, a space virtually set in the information processing device 100 by implementation design computer aided design (CAD) for layout design. The layout data includes information included in the net list, information of actual shapes of components and nets, and positional information on the board. In the implementation design, computer aided manufacturing (CAM) data is generated.

In the analysis, analysis is conducted using the layout data so as to check whether or not a problem occurs upon the manufacturing. The analysis is similar to the floor planning and the analysis in the specification design and the circuit design. However, since the layout data is generated, the accuracy of the analysis is high. After the analysis is terminated, the CAM data is generated by converting the layout data in the implementation design. The CAM data is provided to a production line of a factory and used to manufacture the printed board.

Next, restrictive requirements to be set in the circuit design are described briefly.

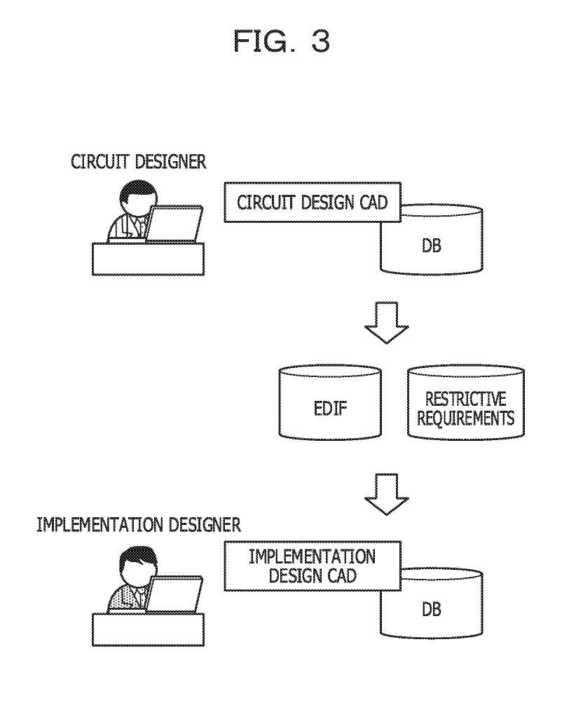

FIG. 3 is an explanatory diagram illustrating an example in which the restrictive requirements are transmitted and received. Traditionally, restrictive requirements have been provided from a circuit designer to an implementation designer in the form of a paper document that is called an implementation instruction in some cases, for example. In recent years, restrictive requirements are provided from circuit design CAD to implementation design CAD in the form of data in some cases, for example.

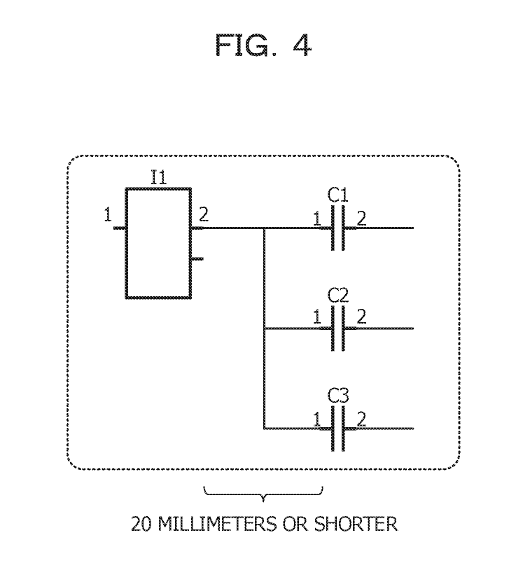

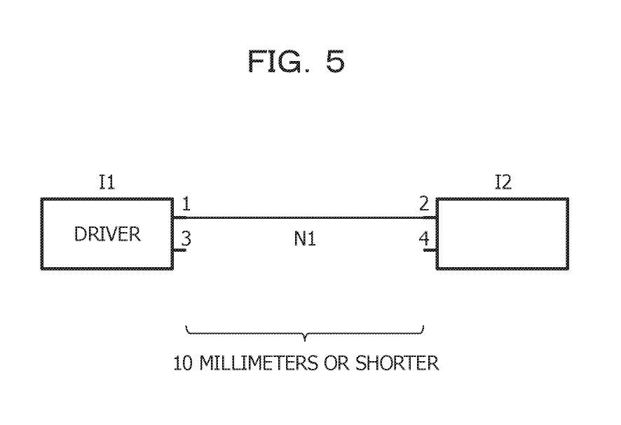

Specifically, the restrictive requirements are transmitted and received in the form of data together with a net list expressed in an electronic design interchange format (EDIF) that is a format for exchange of electronic design data or the like, for example. Next, details to be specified in the restrictive requirements are described with reference to FIGS. 4 and 5.

FIG. 4 is an explanatory diagram illustrating an example of an instruction to arrange components in accordance with a restrictive requirement. The instruction to arrange the components is an instruction to arrange a component in the vicinity of each of arbitrary components, for example. The component C1, the component C2, and a component C3 are arranged at positions separated by 20 mm or less from the component I1.

FIG. 5 is an explanatory diagram illustrating an example of an instruction for a wiring length of a net based on a restrictive requirement. The instruction for the wiring length of the net is an instruction to set the wiring length of the net connected between component pins, for example. For example, a wiring length of a net between a component pin I1.1 and a component pin I2.2 is set to a 10 mm or less.

The circuit designer specifies wiring lengths of nets between pins on a net basis upon the entry of restrictive requirements after the generation of a circuit diagram.

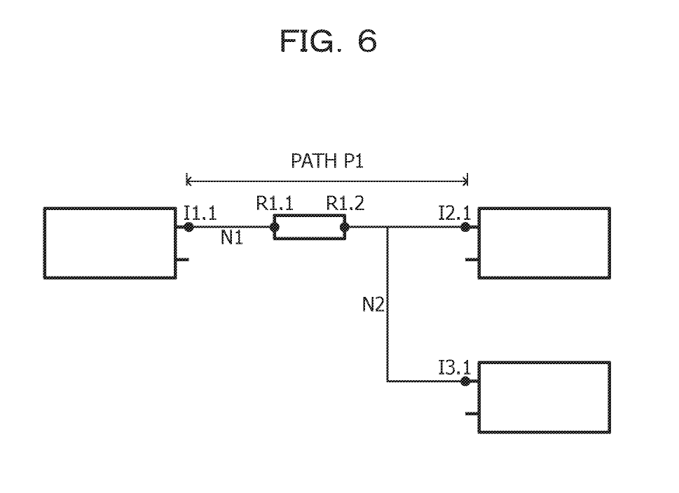

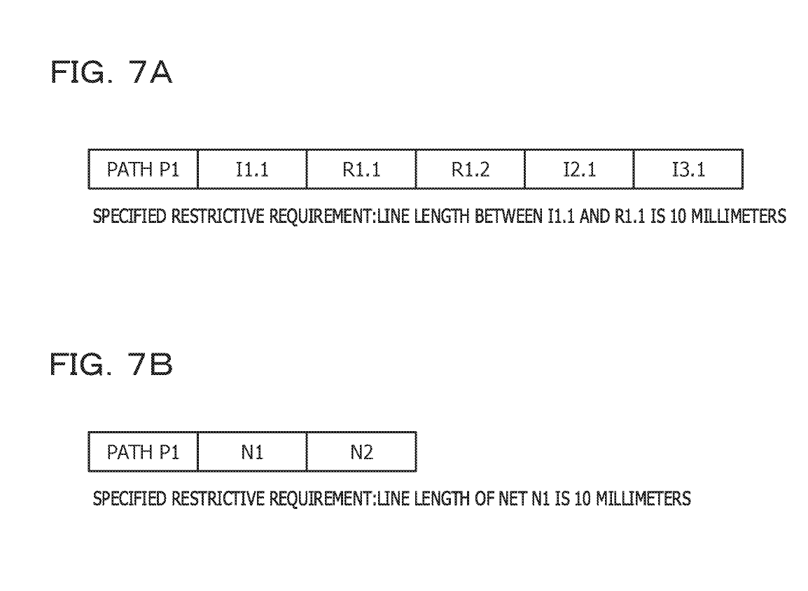

FIG. 6 is an explanatory diagram illustrating an exemplary circuit. FIGS. 7A and 7B are explanatory diagrams illustrating examples of restrictive requirements specified for the exemplary circuit illustrated in FIG. 6. The circuit illustrated in FIG. 6 includes a path P1 that extends from the component pin I1.1 to a component pin I2.1. FIGS. 7A and 7B illustrate examples of an instruction for the wiring length of the path P1 illustrated in FIG. 6.

FIG. 7A illustrates the example in which component pins on the path P1 are listed and the instruction for the wiring length is provided based on a list of the component pins. For example, the path P1 extends from the component pin I1.1 to a component pin I3.1 through a component pin R1.1, a component pin R1.2, and the component pin I2.1. Thus, for example, an instruction is provided to ensure that “a wiring length between the component pin I1.1 and the component pin R1.1 is set to 10 mm”. FIG. 7B illustrates the example in which nets N1 and N2 on the path P1 are listed and the instruction for the wiring length is provided based on a list of the nets. The path P1 includes the net N1 and the net N2. Thus, for example, an instruction is provided to ensure that “the wiring length of the net N1 is set to 10 mm”.

As illustrated in FIGS. 6, 7A, and 7B, for example, the circuit designer manually sets the restrictive requirements based on the lists. Traditionally, however, since it is difficult to imagine a topology, it is difficult for a designer to set a restrictive requirement for a complex path, depending on the skill of the designer.

If restrictive requirements are managed using a list, there may be a misunderstanding between the circuit designer and the implementation designer. Thus, wirings may be mounted by the implementation designer based on a topology that is not intended by the circuit designer.

In the embodiment, the information processing device 100 generates, for each of paths for which requirements are to be set, association data indicating association relationships between component pins on the path and nodes indicated by topology data and displays the association data, the topology data, and the requirement entry field. Thus, the circuit designer may set the restrictive requirements while looking at the topology diagram on the screen.

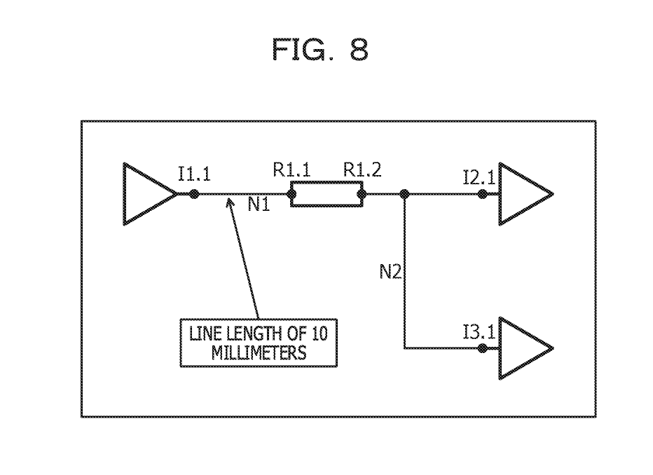

FIG. 8 is an explanatory diagram illustrating an example of a restrictive requirement entered based on a topology displayed on a GUI. The information processing device 100 displays the topology diagram on the GUI (graphic user interface) on a display or the like. The designer may select an arbitrary interval and enter a line length. Since the entered restrictive requirement is transmitted as data from circuit CAD to implementation CAD, the same details may be shared between the circuit CAD and the implementation CAD, for example.

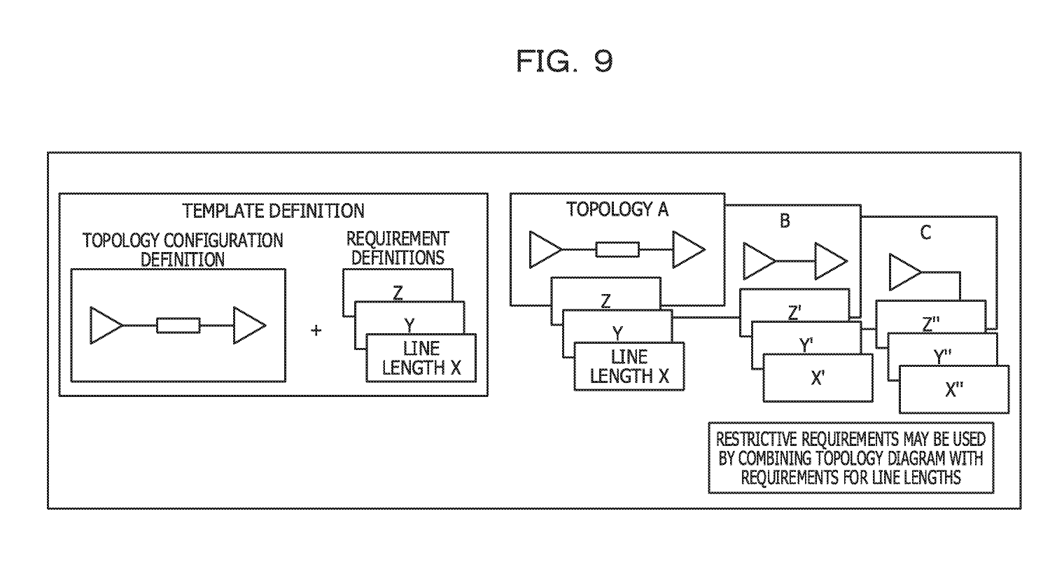

FIG. 9 is an explanatory diagram illustrating an example in which restrictive requirements are converted into templates. Information in which topologies are defined may be converted into templates by combining the information with information in which the restrictive requirements are defined. Thus, a desired topology diagram may be combined with requirements for line lengths and used.

### Example of Hardware Configuration of Information Processing Device 100

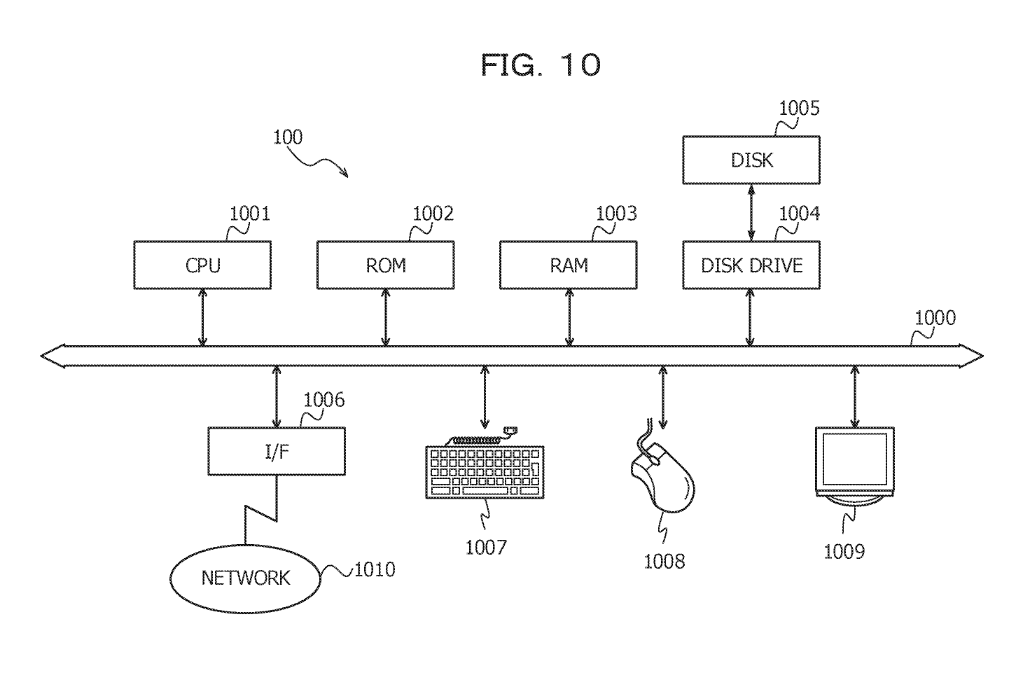

FIG. 10 is a block diagram illustrating an example of a hardware configuration of the information processing device. Referring to FIG. 10, the information processing device 100 has a central processing unit (CPU) 1001, a read only memory (ROM) 1002, a random access memory (RAM) 1003, a disk drive 1004, and a disk 1005. The information processing device 100 has an interface (I/F) 1006, a keyboard 1007, a mouse 1008, and a display 1009. The CPU 1001, the ROM 1002, the RAM 1003, the disk drive 1004, the I/F 1006, the keyboard 1007, the mouse 1008, and the display 1009 are connected to each other by a bus 1000.

The CPU 1001 controls the overall information processing device 100. The ROM 1002 stores programs including a boot program. The RAM 1003 is used as a work area of the CPU 1001. The disk drive 1004 controls reading and writing of data from and in the disk 1005 in accordance with control by the CPU 1001. The disk 1005 stores data written in accordance with control by the disk drive 1004. The disk 1005 is a magnetic disk, an optical disc, or the like, for example.

The I/F 1006 is connected through a communication line to a network 1010 such as a local area network (LAN), a wide area network (WAN), or the Internet and is connected to another device through the network 1010. The I/F 1006 serves as an interface between the network 1010 and the inside of the information processing device 100 and controls input and output of data from and to the external device. As the I/F 1006, a modem, a LAN adapter, or the like may be used, for example.

The keyboard 1007 and the mouse 1008 are interfaces for inputting data of various types by user operations. The display 1009 is an interface for outputting data in accordance with an instruction from the CPU 1001.

The information processing device 100 may have an input device for acquiring an image and a video image from a camera and have an input device for acquiring a sound from a microphone, although an illustration of the input devices is omitted. In addition, the information processing device 100 may have an output device such as a printer, although an illustration of the output device is omitted.

In the embodiment, the personal computer is described as the example of the hardware configuration of the information processing device 100, but the information processing device 100 is not limited to this and may be a server or the like. If the information processing device 100 is a server, the information processing device 100, a device that is operable by a user, the display 1009, and the like may be connected to each other through the network 1010.

### Example of Functional Configuration of Information Processing Device 100

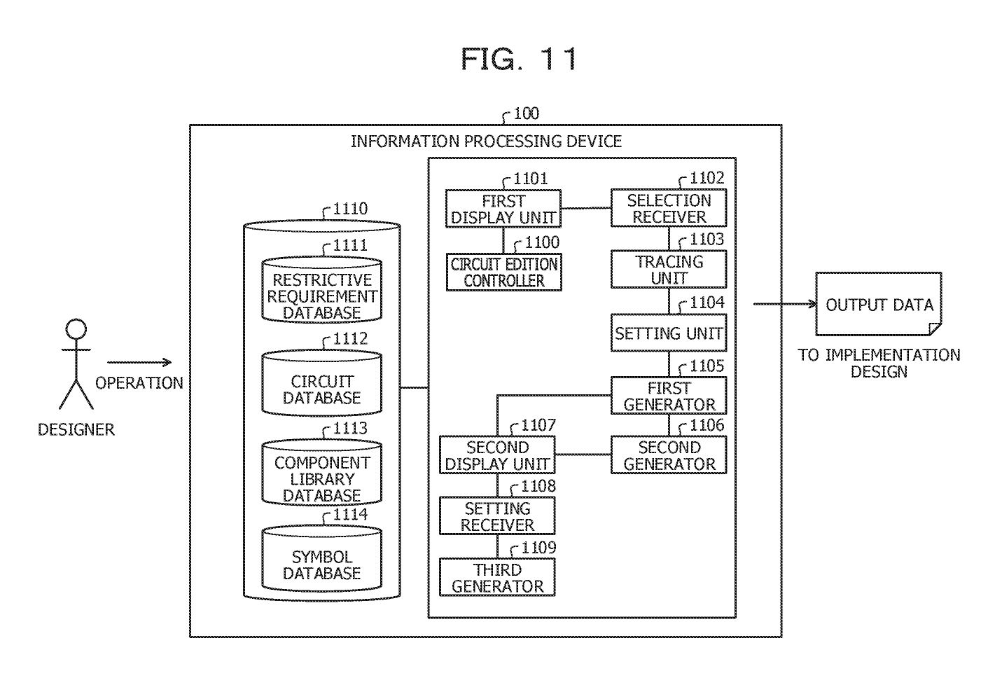

FIG. 11 is a block diagram illustrating an example of a functional configuration of the information processing device. The information processing device 100 has a circuit edition controller 1100, a first display unit 1101, a selection receiver 1102, a tracing unit 1103, a setting unit 1104, a first generator 1105, and a second generator 1106. In addition, the information processing device 100 has a second display unit 1107, a setting receiver 1108, a third generator 1109, and a storage unit 1110. The storage unit 1110 is achieved by storage devices such as the ROM 1002, the RAM 1003, and the disk 1005. Processes of the controlling units from the circuit edition controller 1100 to the third generator 1109 are coded into a program stored in the storage unit 1110 that is able to be accessed by the CPU 1001 illustrated in FIG. 10, for example. The CPU 1001 reads the program from the storage unit 1110 and executes the processes coded in the program. The processes of the controlling units are achieved by the execution of the processes. Results of the processes of the controlling units are stored in the storage unit 1110 achieved by the RAM 1003, the ROM 1002, the disk 1005, and the like, for example.

The storage unit 1110 includes a restrictive requirement database 1111, a circuit database 1112, a component library database 1113, and a symbol database 1114, for example. Each of the databases is abbreviated to a DB in some cases.

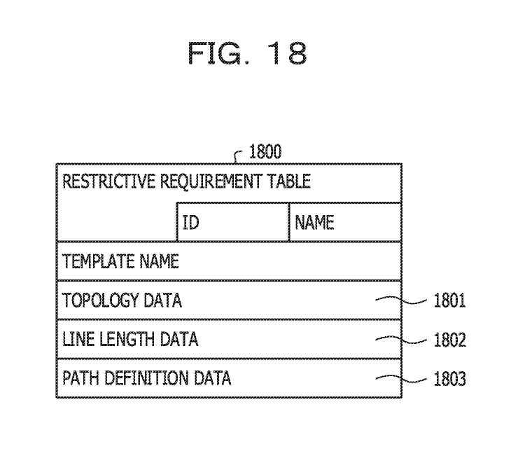

The restrictive requirement DB 1111 stores a restrictive requirement table indicating restrictive requirements set by the designer, for example. A detailed example of the restrictive requirement table stored in the restrictive requirement DB 1111 is illustrated in FIG. 18 described later. The circuit DB 1112 is circuit information indicating components included in the circuit designed by the designer and connection relationships between the components included in the circuit designed by the designer. A detailed example of the circuit DB 1112 is illustrated in FIG. 12 described later. The component library DB 1113 is a library of the components used in the circuit. The designer selects components to be used from the component library DB 1113 and arranges the selected components in the circuit diagram in the simulation space. A detailed example of the component library DB 1113 is omitted.

FIG. 12 is an explanatory diagram illustrating an example of the circuit database. Referring to FIG. 12, the circuit DB 1112 includes a circuit diagram table 1200, component tables 1201, component pin tables 1203, and net tables 1202, for example. The tables of the four types are linked. In FIG. 12, “1” indicates a single table and “*” indicates multiple tables. For example, “1” is described for the circuit diagram table 1200 and “*” is described for the net tables 1202 and the component tables 1201. This is due to the fact that the multiple net tables 1202 and the multiple component tables 1201 are provided for the single circuit diagram table 1200.

The circuit diagram table 1200 is a data table to be used to manage information of the overall circuit diagram, for example. The single circuit diagram table 1200 is generated for the single circuit diagram, for example. The circuit diagram table 1200 includes link information indicating links to the multiple component tables 1201 and the multiple net tables 1202.

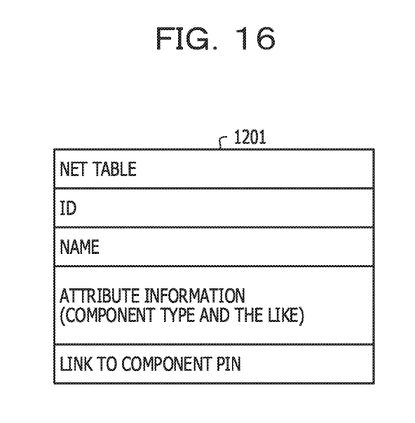

The component tables 1201 are data tables to be used to manage information of the components included in the circuit diagram, for example. For example, when a component is added to the circuit diagram by the designer, a single component table 1201 is added. Each component table 1201 is linked to one or multiple component pin tables 1203. A detailed example of the component tables 1201 is illustrated in FIG. 16.

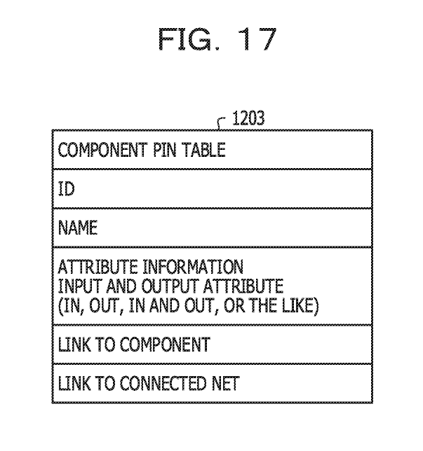

The component pin tables 1203 are used to manage information of component pins of components, for example. A component pin table 1203 for a component pin is linked to a parent component table 1201 and linked to a net table 1202 for a net connected to the component pin, for example. The number of component pins of each component is defined in the component library DB 1113. A detailed example of the component pin tables 1203 is illustrated in FIG. 17.

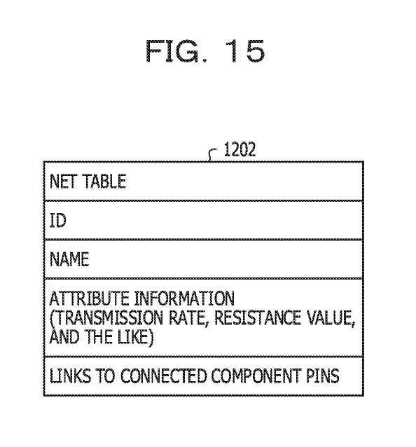

The net tables 1202 are used to manage information of nets included in the circuit diagram. When a single net table 1202 for a net is added, the added net table 1202 is linked to a component pin table 1203 for a component pin connected to the net. A detailed example of the net tables 1202 is illustrated in FIG. 15.

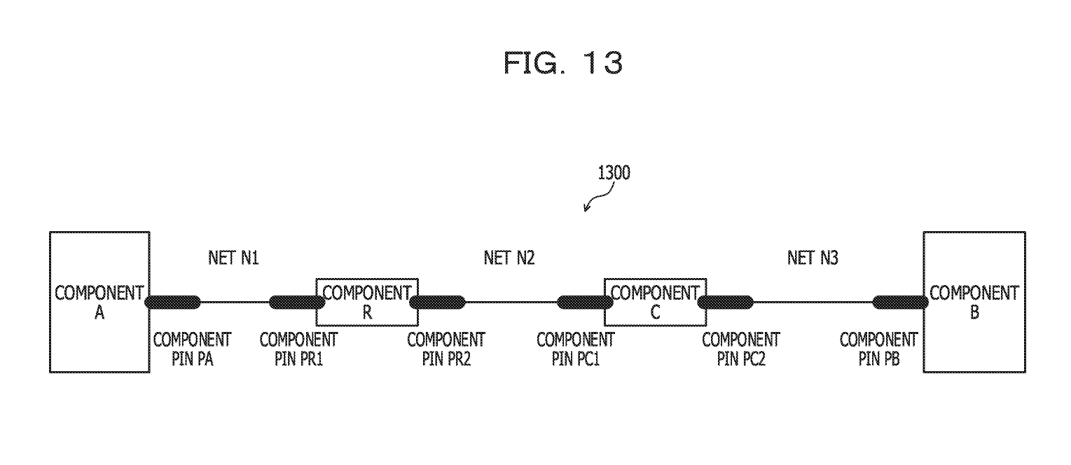

FIG. 13 is an explanatory diagram illustrating an exemplary circuit. The circuit 1300 includes a component A, a component R, a component C, and a component B. A component pin PA of the component A and a component PR1 of the component R are connected to each other by a net N1. A component pin PR2 of the component R and a component pin PC1 of the component C are connected to each other by a net N2. A component pin PC2 of the component C and a component pin PB of the component B are connected to each other by a net N3.

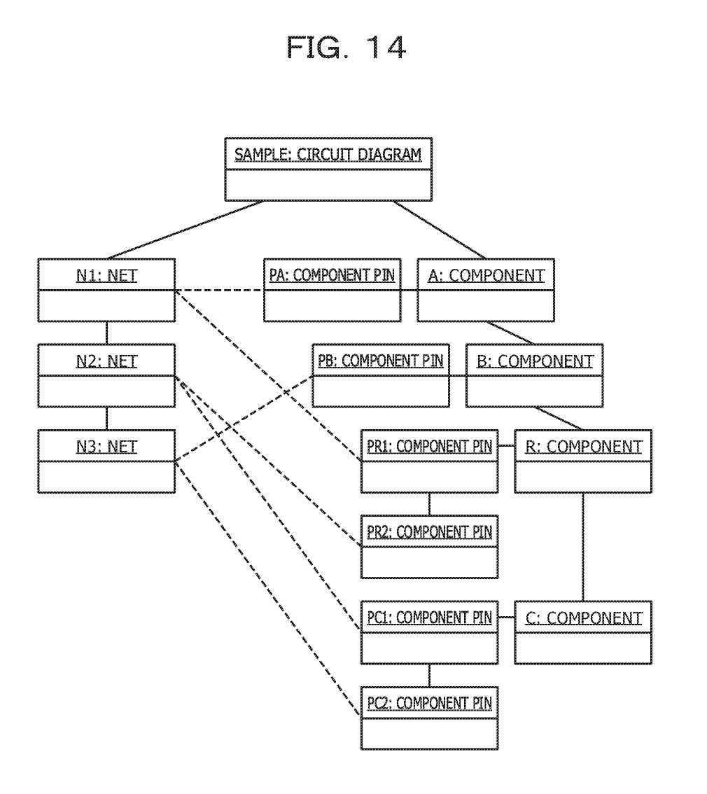

FIG. 14 is an explanatory diagram illustrating an example of the circuit database indicating the circuit illustrated in FIG. 13. In the example illustrated in FIG. 14, tables to which the component names A, B, R, C, and the like are added are component tables 1201. In the example illustrated in FIG. 14, tables to which net names N1 to N3 and the like are added are net tables 1202. In the example illustrated in FIG. 14, tables to which component pin names PA, PB, PR1, PR2, PC1, PC2, and the like are added are component pin tables 1203.

In FIG. 14, dotted lines indicate that the net tables 1202 and the component pin tables 1203 are linked, for example.

FIG. 15 is an explanatory diagram illustrating the example of the net tables. The net tables 1202 indicate the nets, for example. The net tables 1202 are generated for the nets, respectively. The net tables 1202 each include an ID field, a name field, attribute information field, a field for links to component pins connected to a net, and the like. The net tables 1202 are stored in the storage unit 1110, for example.

In the ID field, identification information that uniquely identifies the net is set, for example. In the name field, the name of the net is set, for example. In the attribute information field, information that indicates characteristics of the net is set, for example. As the information that indicates the characteristics of the net, a transmission rate, a resistance value, information indicating whether the net is a VDD net or a VSS net if the net is connected to a power source or a VDD, and the like are set, for example. In the field for links to component pins connected to the net, link information that indicates links to component pin tables 1203 for the connected component pins is set. The link information may be pointers pointing to the component pin tables 1203 or may be identification information that uniquely identifies the connected component pins, for example.

FIG. 16 is an explanatory diagram illustrating the example of the component tables. The component tables 1201 are involved in the components. The component tables 1201 are generated for the components, respectively. The component tables 1201 each include an ID field, a name field, an attribute information field, a field for a link to a component pin, for example. The component tables 1201 are stored in the storage unit 1110, for example.

In the ID field, identification information that uniquely identifies a component is set, for example. In the name field, the name of the component is set, for example.

In the attribute information field, information that indicates a characteristic of the component is set, for example. The information that indicates the characteristic of the component is identification information that indicates the type of the component, for example. The type of the component is a component type such as a resistor, a capacitor, a coil, an IC, or the like, for example. The type of the component may be a component type such as a driver or a receiver, for example. The information that indicates the characteristic of the component may be information of an instruction to arrange the component, for example.

In the field for a link to a component pin, link information that indicates a link to a component pin table 1203 for the component pin included in the component is set, for example. The link information may be a pointer pointing to the component pin table 1203 or may be identification information that uniquely identifies the component pin, for example.

FIG. 17 is an explanatory diagram illustrating the example of the component pin tables. The component pin tables 1203 indicate component pins, for example. The component pin tables 1203 each include an ID field, a name field, an attribute information field, a field for a link to a component, a field for a link to a connected net, for example. The component pin tables 1203 are stored in the storage unit 1110, for example.

In the ID field, identification information that uniquely identifies a component pin is set, for example. In the name field, the name of the component pin is set, for example.

In the attribute information field, information that indicates characteristics of the component pin is set, for example. The information that indicates the characteristics of the component pin is information of an input and output attribute, for example. The input and output attribute indicates input (In), output (Out), input and output (Inout), or the like, for example.

In the field for a link to a component, link information that indicates a link to a component table 1201 for a component that includes the target component pin is set. The link information may be a pointer pointing to the component table 1201 or may be identification information that uniquely identifies the component, for example. In the field for a link to a connected net, link information that indicates a link to a net table 1202 for a net connected to a net connected to the target component pin is set. The link information may be a pointer pointing to the net table 1202 or may be identification information that uniquely identifies the connected net, for example.

FIG. 18 is an explanatory diagram illustrating an example of the restrictive requirement table. A restrictive requirement table 1800 is a database that stores restrictive requirements entered by the designer, for example. The restrictive requirement table 1800 is registered in the restrictive requirement database 1111.

The restrictive requirement table 1800 includes an ID field, a name field, a template name field, a field for topology data 1801, a field for line length data 1802, and a field for path definition data 1803.

In the ID field, identification information that uniquely identifies a restrictive requirement is set. In the name field, the name of the restrictive requirement is set. The name of a template is set in the template name field if template data is used.

In the field for the topology data 1801, data that indicates a topology for a path for which the requirement is to be set is set. In the field for the line length data 1802, a line length to be set, the type of the line length, and the like are set. In the field for the path definition data 1803, association data that indicates association relationships between pins of components included in a path and nodes included in a topology is set for each of paths for which requirements are to be set.

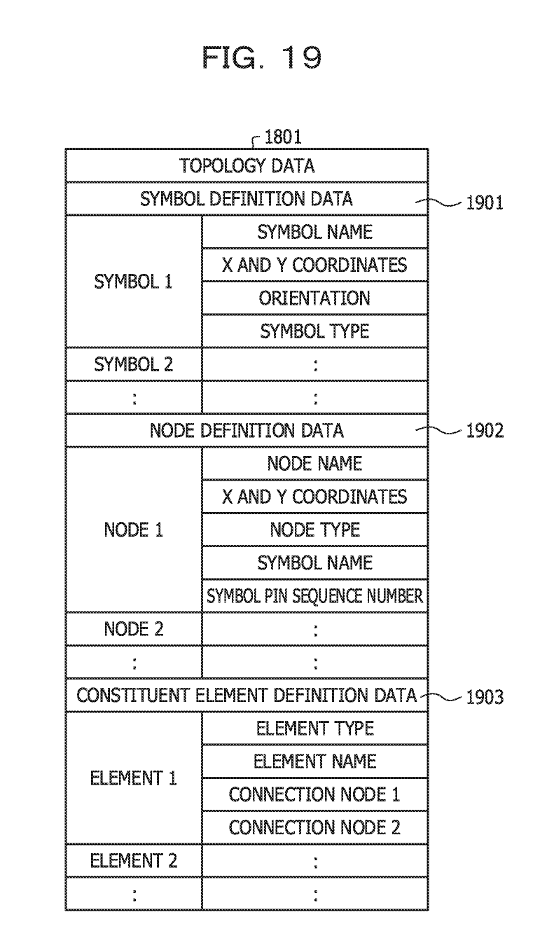

FIG. 19 is an explanatory diagram illustrating an example of the topology data. The topology data 1801 includes symbol definition data 1901, node definition data 1902, and constituent element definition data 1903, for example. The topology data 1801 is stored in the storage unit 1110.

The symbol definition data 1901 defines symbols included in a topology, for example. The symbol definition data 1901 includes a symbol name field, a field for X and Y coordinates, an orientation field, and a symbol type field for each of the symbols. In the symbol name field, the name of the symbol that is uniquely identified in the topology data 1801 is set. In the field for X and Y coordinates, coordinate values that indicate the position of the symbol on a diagram upon the display of the topology are set. In the orientation field, an orientation in which the symbol is drawn upon the display of the topology is set. As the orientation, an angle with respect to the shape of a symbol serving as a template may be set, for example. If “0” is set, the symbol is arranged without a change in the orientation of the symbol. If “180” is set, the symbol is arranged while being reversed. In the symbol type field, a symbol type such as a driver, a receiver, a resistor, a capacitor, a power source, or a ground is set.

For example, in the symbol definition data 1901, the following details indicated within quotation marks are described: “SYM1, 100, 200, 0, DRV”, “SYM2, 500, 600, 0, RCV”, and “SYM3, 1000, 500, 0, GND”.

The above description example of the symbol definition data 1901 indicates that a symbol of a driver is defined as SYM1 and defined to be arranged at a position (100, 200) in an orientation of “0”. The above description example of the symbol definition data 1901 indicates that a symbol of a receiver is defined as SYM2 and defined to be arranged at a position (500, 600) in an orientation of “0”. The above description example of the symbol definition data 1901 indicates that a symbol of a ground is defined as SYM3 and defined to be arranged at a position (1000, 500) in an orientation of “0”.

The node definition data 1902 is information of joint points at which elements are connected to each other. The node definition data 1902 includes a node name field, a field for X and Y coordinates, a node type field, a symbol name field, and a symbol pin sequence number field. In the node name field, the name of a node that is uniquely identified in the topology data 1801 is set. In the field for X and Y coordinates, coordinate values that indicate the position of the node on the diagram upon the display of the topology data 1801 are set. In the node type field, a “symbol pin (SYMPIN)” or a “net branch point (DIV)” is set. If the node corresponds to a pin of a symbol corresponding to a component, the “symbol pin SYMPIN” is set in the node type field. If the node corresponds to a net branch point, the “net branch point (DIV)” is set in the node type field. If the node is a symbol pin, the name of the symbol pin corresponding to the node is set in the symbol pin sequence number field.

For example, in the node definition data 1902, the following details indicated within quotation marks are described: “NODE1, 110, 210, SYMPIN, SYM1, 01” and “NODE2, 300, 400, DIV”.

The above description example of the node definition data 1902 indicates that NODE1 is defined to be located at a position (110, 210) and is defined to be a node of a symbol pin and to correspond to a pin 01 of SYM1. In addition, the above description example of the node definition data 1902 indicates that NODE2 is defined to be located at a position (300, 400) and to correspond to a node of a net branch point.

The constituent element definition data 1903 is configuration information of the topology and is also connection information that indicates how elements defined by the symbol definition data 1901 and the node definition data 1902 are connected. The constituent element definition data 1903 includes an element type field, an element name field, a field for a connection node 1, and a field for a connected node 2 for each of the elements.

In the element type field, a “symbol (SYMBOL)” or a “net branch point” is set. If an element type indicates the “symbol”, a symbol name is set in the element name field. In the field for a connection node 1, the name of a node belonging to the element is set. In the field for a connection node 2, the name of a node belonging to the element is set. The field for a connection node 2 is used if the element is a net branch point or a dual-terminal component such as a resistor.

For example, in the constituent element definition data 1903, the following details indicated within quotation marks are described: “SYMBOL, SYM1, NODE1” and “DIV, NODE1, NODE2”.

The above description example of the constituent element definition data 1903 indicates that SYM1 is connected to NODE1 and NODE1 is connected to NODE2. The fact that NODE1 is connected to NODE2 indicates that NODE2 is connected to a branch point of a net connected to NODE1.

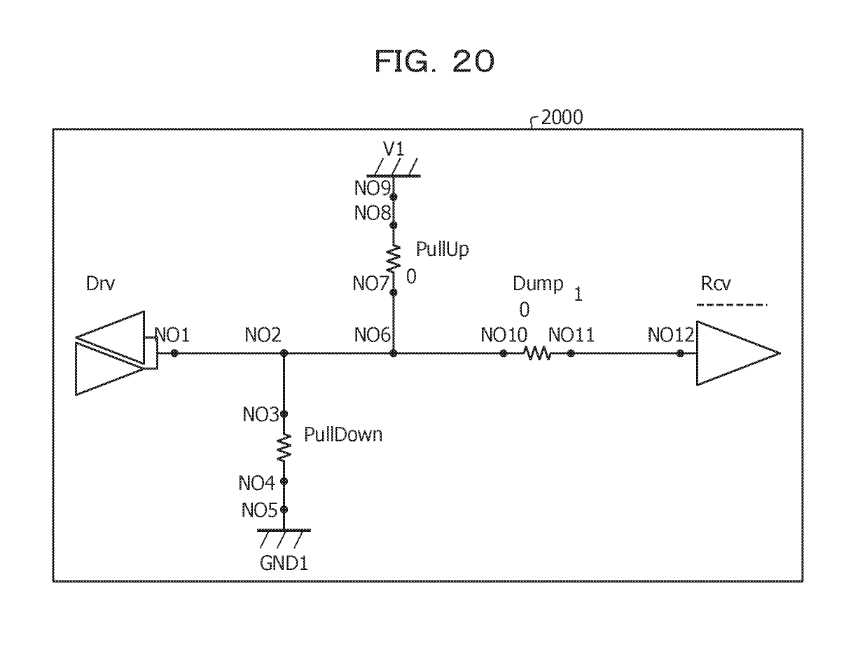

FIG. 20 illustrates an example of an image of a topology. In an example of a topology diagram 2000, Dry is represented by a symbol of a driver. In the example of the topology diagram 2000, Dump, PullUp, and PullDown are represented by symbols of receivers. In the example of the topology diagram 2000, Rcv is represented by a symbol of a receiver. Nodes are represented by NO1 to NO12.

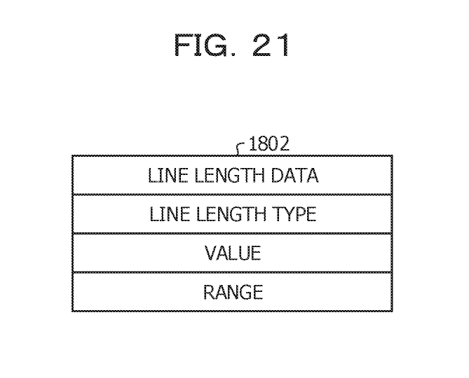

FIG. 21 is an explanatory diagram illustrating an example of the line length data. The line length data 1802 is information indicating a line length set as a requirement. For example, the line length data 1802 includes a line length type field, a value field, and a range field. In the line length type field, a type that indicates a specified range of the line length, such as a total line length, a line length between pins, or a line length between nodes, is set. For example, if the type indicates a line length between nodes, the type of the line length may be expressed by the names of the two nodes. In the value field, a value of the specified line length is set. In the range field, “not shorter (≧)”, “not longer (≦)”, “longer (>)”, “shorter (<)”, “tolerance (±)” or the like is set.

For example, in the line length data 1802, the following details within quotation marks are described: “PIN_TO_PIN, 100, ≧”.

The above description example of the line length data 1802 indicates that pins are connected to each other by a line of 100 mm or longer.

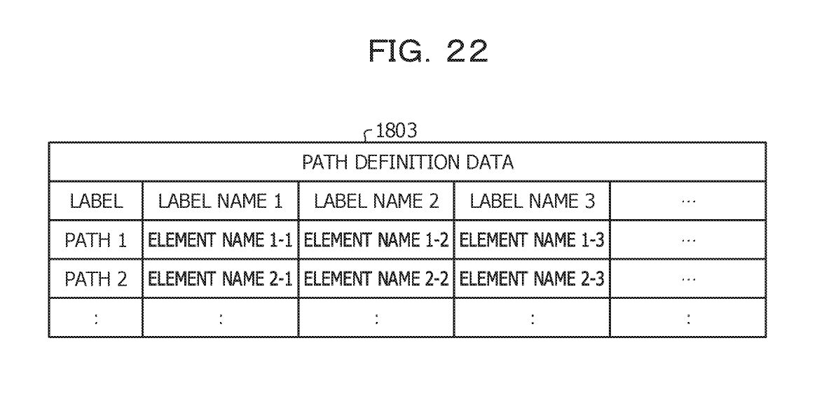

FIG. 22 is an explanatory diagram illustrating an example of the path definition data. The path definition data 1803 includes, for each of paths for which requirements are to be set, association data indicating association relationships between component pins included in the path and nodes included in a topology.

The path definition data 1803 includes, for each of the paths, a label field and fields for the names of elements included in the path, for example. In the label field, the names of nodes on the topology data 1801 are set. In the fields for the names of elements included in the path, the names of component pins on the circuit diagram are set or information that indicates the pins to be assigned to the nodes on the topology is set.

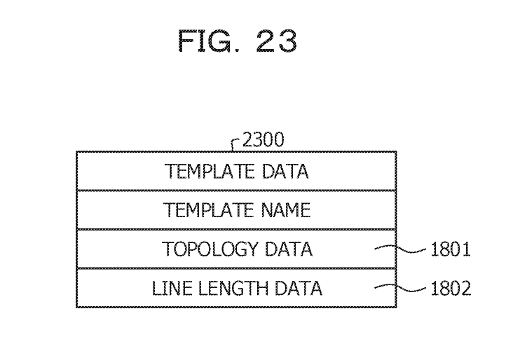

FIG. 23 is an explanatory diagram illustrating an example of the template data. Template data 2300 indicates templates able to be used as multiple restrictive requirements. The template data 2300 includes a template name field, a field for the topology data 1801, and a field for the line length data 1802.

In the template name field, the name of a template that is uniquely defined in the restrictive requirement database 1111 is set. In the field for the topology data 1801, the topology data 1801 selected as a template by a user is set. The information format of the topology data 1801 is illustrated in FIG. 19. In the field for the line length data 1802, the line length data 1802 selected as a template by the user is set. The information format of the line length data 1802 is illustrated in FIG. 21.

The description of the formats of the information is finished. Returning to FIG. 11, the units are described below in detail.

The first display unit 1101 displays the circuit diagram in the simulation space based on the circuit database 1112. The circuit edition controller 1100 edits the circuit database 1112 based on a designer's operation executed on the displayed circuit diagram. The designer's operation is an operation of an input device such as the keyboard 1007 or the mouse 1008.

The selection receiver 1102 receives selection of an element that is included in the circuit diagram displayed in the simulation space and for which a restrictive requirement is to be set.

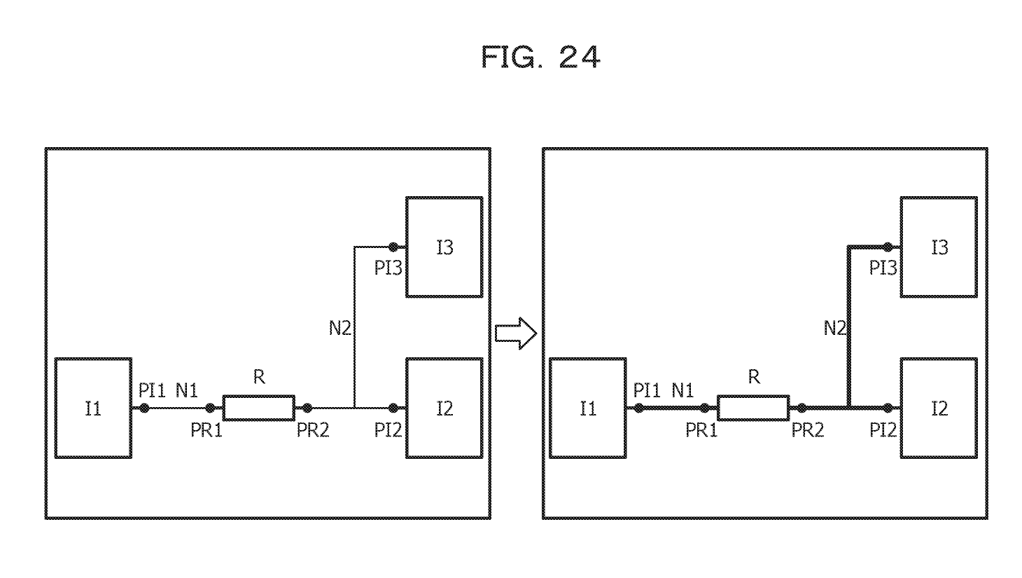

FIG. 24 is an explanatory diagram illustrating an example of the selection. If the circuit diagram is displayed on the display 1009, the selection receiver 1102 receives input of an operation of the input device such as the keyboard 1007 or the mouse 1008 by the designer and thereby receives selection of an element on the circuit diagram. In the example illustrated in FIG. 24, the net N1, the component R, and the net N2 are selected. The net N1 connects a component pin PI1 of the component I1 to the component pin PR1 of the component R. The net N2 connects the component pin PR2 of the component R to a component PI2 of the component I2 and connects the component pin PR2 of the component R to a component pin PI3 of a component I3.

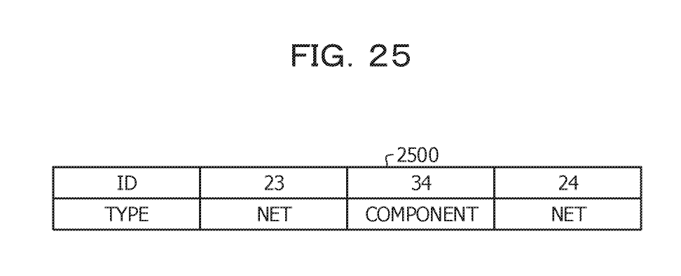

FIG. 25 is an explanatory diagram illustrating an example of a selected element table. The selection receiver 1102 associates the IDs of the selected elements with the types of the selected elements and causes the IDs and types of the selected elements to be stored in a selected element table 2500. The ID of the net N1 is “23”. The ID of the component R is “34”. The ID of the net N2 is “24”. Each of the types of the nets N1 and N2 is a net. The type of the component R is a component.

Next, the tracing unit 1103 searches paths included in the circuit diagram and including the selected elements based on the circuit database 1112. The number of the paths to be searched is two or more, drivers of the paths are the same, and at least receiving components of the paths among all receivers of the paths are the same.

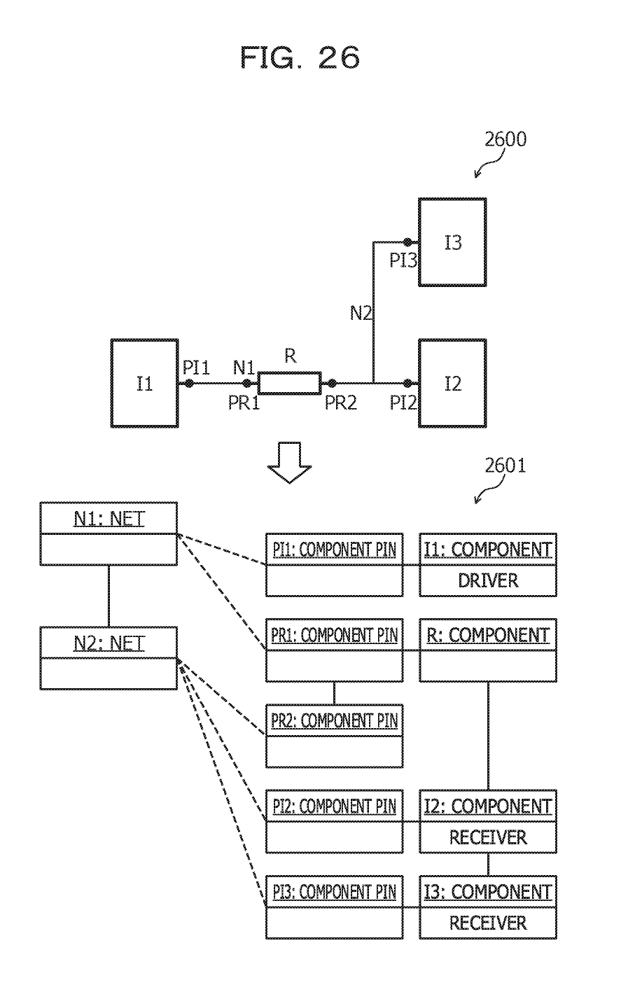

Specifically, the tracing unit 1103 acquires component pin tables 1203 for connection pins of the selected elements stored in the selected element table 2500 and causes the acquired component pin tables 1203 to be stored in a path trace DB, for example. Then, the tracing unit 1103 acquires net tables 1202 for the nets connected to the connection pins and causes the acquired net tables 1202 to be stored in the path trace DB. Then, the tracing unit 1103 acquires component tables 1201 for components connected to the nets and component pin tables 1203 for the components connected to the nets and causes the acquired component tables 1201 and the acquired component pin tables 1203 to be stored in the path trace DB. The path trace DB is illustrated in FIG. 26 described later.

If the components connected to the nets are passive components, the tracing unit 1103 treats the components connected to the nets as newly selected elements, acquires the component pin tables 1203 for the connection pins, and causes the acquired connection pin tables 1203 to be stored in the path trace DB.

The tracing unit 1103 does not cause a table already stored in the path trace DB to be redundantly stored. In this manner, the elements that are on the paths including the selected elements may be identified.

FIG. 26 is an explanatory diagram illustrating an example of the circuit and path trace DB. An upper part of FIG. 26 illustrates an exemplary circuit 2600 to be designed. A lower part of FIG. 26 illustrates an exemplary path trace DB 2601 for the circuit 2600.

Next, the setting unit 1104 determines whether each of the components indicated by the component tables 1201 stored in the path trace DB 2601 is a driver or a receiver. Specifically, the setting unit 1104 adds priorities to the components indicated by the component tables 1201 based on the following determination of four types. Then, the setting unit 1104 sets a “driver” as a type in an attribute information field of a component table 1201 for a component with a high priority.

In the first determination, the setting unit 1104 increases priorities of components that are not a passive component. In the second determination, the setting unit 1104 increases priorities based on pin attributes so as to ensure that a value added to a priority of a component with an output pin>a value added to a priority of a component with an input and output pin>a value added to a priority of a component with an input pin. In the third determination, the setting unit 1104 increases priorities of components with small ID numbers. In the fourth determination, the setting unit 1104 increases priorities based on component pin IDs so as to ensure that as a component pin ID of a component pin is smaller, an increased degree of a priority of a component with the component pin is larger.

For example, the setting unit 1104 determines whether or not the priorities satisfy a specific priority requirement. A case where a priority satisfies the specific priority requirement is when the priority is the highest among the priorities or is the highest or the second highest among the priorities, for example. The specific priority requirement may be specified by the designer. For example, if the priority satisfies the specific priority requirement, the setting unit 1104 treats the priority as a high priority and sets a “driver” in an attribute information field of a component table 1201 of a component with the priority. For example, if a component is not a passive component and has a priority that does not satisfies the specific priority requirement, the setting unit 1104 does not treats the priority as the high priority and sets a “receiver” in an attribute information field of a component table 1201 of the component with the priority.

As illustrated in FIG. 26, the component I1 is the driver, and the components I2 and I3 are receivers.

Next, the first generator 1105 generates topology data 1801 indicating wiring states of the searched paths. In this case, the first generator 1105 generates the topology data 1801 based on symbols corresponding to components included in a path that is among the searched paths and satisfies the predetermined requirement, nodes corresponding to terminals of the components included in the path satisfying the predetermined requirement, and nodes corresponding to branch points of connection lines. The path that satisfies the predetermined requirement includes the components whose number is the largest among the searched paths, for example.

Specifically, the first generator 1105 generates the topology data 1801 based on the path trace DB 2601, for example.

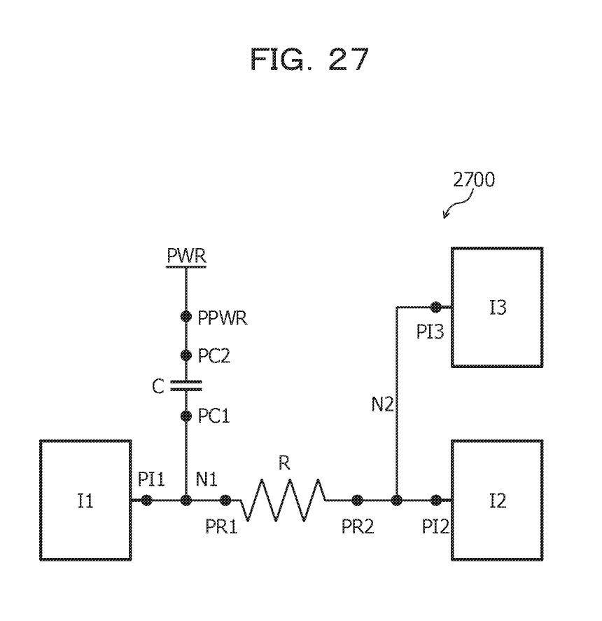

FIG. 27 is an explanatory diagram illustrating an exemplary circuit to be used for the generation of the topology data. The circuit 2700 includes the component I1, the component C, the component R, the component I2, the component I3, and a power source PWR, for example. The component I1, the component R, and the component C are connected to each other by the net N1. The component R, the component I2, and the component I3 are connected to each other by the net N2.

The component pin of the component I1 is PI1. The component pins of the component R are PR1 and PR2. A component pin of the power source PWR is PPWR. The component pins of the component C are PC1 and PC2. The component pin of the component I2 is PI2. The component pin of the component I3 is PI3.

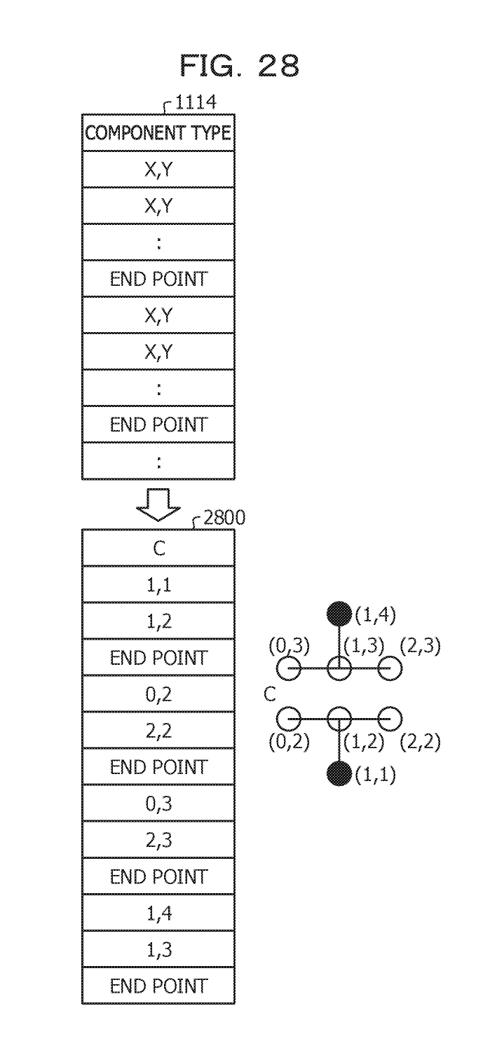

FIG. 28 is an explanatory diagram illustrating an example of the symbol database. The symbol database 1114 includes symbol information for component types. The symbol information includes a component type field and a field for coordinate values of end points of symbols, for example. The end points are connected by lines to form the symbols.

FIG. 28 illustrates an example of symbol information of the component C. Symbol information 2800 is a symbol indicating the capacitor C. In the symbol information 2800, C is set as a component type. The symbol information 2800 includes an end point (1, 1), an end point (1, 2), an end point (0, 2), an end point (2, 2), an end point (0, 3), an end point (2, 3), an end point (1, 4), and an end point (1, 3). The second display unit 1107 displays the symbol while one end point having coordinate values and included in the symbol information is connected to another end point having coordinate values and included in the symbol information. The symbol is displayed while the end point (1, 1) and the end point (1, 2) are connected to each other by the line.

Next, the first generator 1105 divides the topology diagram in the simulation space into multiple columns.

The first generator 1105 generates topology data 1801 for paths indicated by the path trace DB 2601 based on the path that is among the paths indicated by the path trace DB 2601 and includes components whose number is the largest among the paths indicated by the path trace DB 2601. The path trace DB 2601 includes path data on the searched paths. The path data is a table group forming the paths.

The first generator 1105 arranges, based on relationships of connections from the driver indicated by the component tables 1201 included in the path trace DB 2601, symbols indicating components in the columns on the topology diagram in the simulation space.

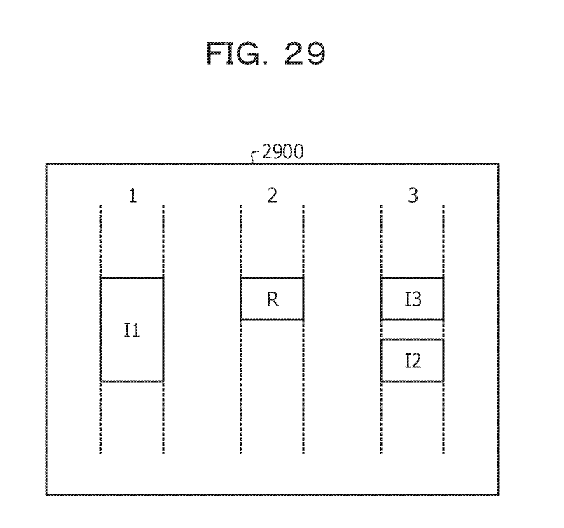

FIG. 29 is an explanatory diagram illustrating an example in which the symbols of the components are arranged on the topology diagram. The first generator 1105 arranges, on a topology diagram 2900, the symbols corresponding to the components in the generated columns in accordance with the relationships of the connections of the nets from the driver, for example. The symbols corresponding to the components are figures prepared for the topology diagram for the component types in advance. The first generator 1105 arranges, in the same column, components that have relationships of connections from the driver and are connected to the same net.

Symbols that indicates components connected to the power source and the ground are treated as symbols to be vertically arranged and are therefore not arranged upon the arrangement of the symbols indicating the components in the columns.

A symbol of the component I1 is arranged in a column 1 on the topology diagram 2900. A symbol of the component R is arranged in a column 2 on the topology diagram 2900. Symbols of the components I2 and I3 connected to the net N2 are arranged in a column 3 on the topology diagram 2900.

The first generator 1105 divides a net connected to components whose symbols are arranged into a main portion and a branch. For example, if the net only connects a first component and a second component to each other, the main portion of the net is the entire net portion between the first component and the second component. If the net connects the first component and the second component to each other and connects the first component and a third component to each other, the main portion of the net is a net portion connecting the first component and the second component to each other and the branch of the net is a net portion connecting the first component and the third component to each other. The first generator 1105 arranges the main portion of the net in a gap between two columns on the topology diagram. The first generator 1105 determines distances between the columns based on whether the branch of the net exists in a gap between columns of symbols arranged on the topology diagram.

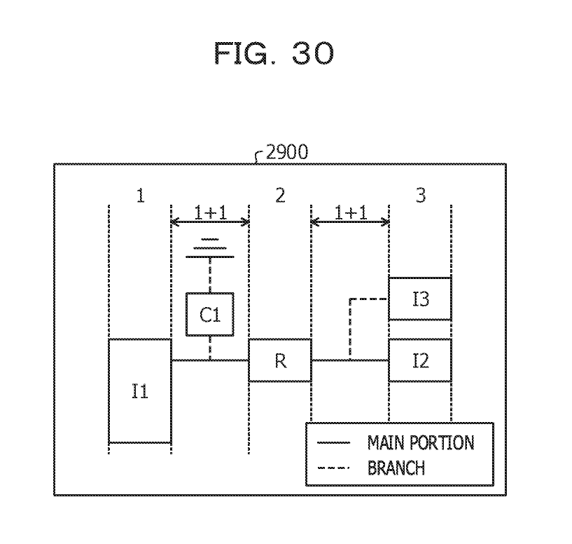

FIG. 30 is an explanatory diagram illustrating an example of the determination of the distances between the columns. A distance between columns in a case where a branch of the net does not exist between the columns is treated as a standard distance. The first generator 1105 treats a distance between columns as 1 in the case where a branch of the net does not exist between the columns.

If the main portion of the net that exists in a gap between adjacent columns includes a branch of a net connected to the power source or the ground, the first generator 1105 sets, as a distance between the columns, a distance obtained by adding 1 to the standard distance. For example, since a branch of the net N1 is connected to the component C1 connected to the power source in a gap between the columns 1 and 2, the distance between the columns 1 and 2 is 2. The first generator 1105 arranges a symbol indicating the component C1 and a symbol indicating the power source on the topology diagram 2900.

If the main portion of the net that exists in a gap between adjacent columns includes a branch of a net connected to components, the first generator 1105 sets, as a distance between the columns, a distance obtained by adding 1 to the standard distance. For example, since a branch of the net N2 is connected to the component I3 in a gap between the columns 2 and 3 on the topology diagram 2900, the distance between the columns 2 and 3 is 2.

If the main portion of the net in the gap between the adjacent columns includes a branch of any net, the first generator 1105 sets, as the distance between the columns, a distance obtained by adding 2 to the standard distance.

If the main portion of the net connects component symbols arranged between columns that are not adjacent to each other, the first generator 1105 sets, as the width of another column, a distance obtained by subtracting the standard distance from a distance between the determined columns.

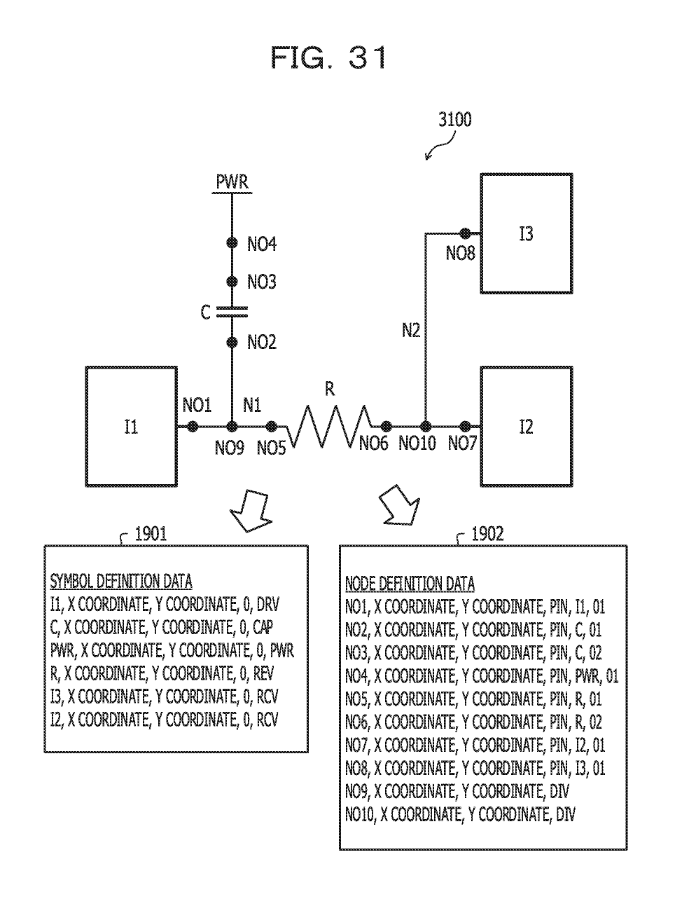

FIG. 31 is an explanatory diagram illustrating an example of the symbol definition data and node definition data. The first generator 1105 generates symbol definition data 1901 defining symbols corresponding to components and the positions of the symbols on a topology 3100.

The first generator 1105 generates node definition data 1902 in which nodes are associated with the branch points of the nets and symbol pins arranged in order from the pin of the driver. In the example illustrated in FIG. 31, the first generator 1105 associates nodes NO1 to NO10 with the branch points and the pins of the symbols indicating components.

Next, the second generator 1106 generates, for each of the searched paths, association data indicating association relationships between pins of components included in the searched path and nodes of a topology indicated by the generated topology data 1801.

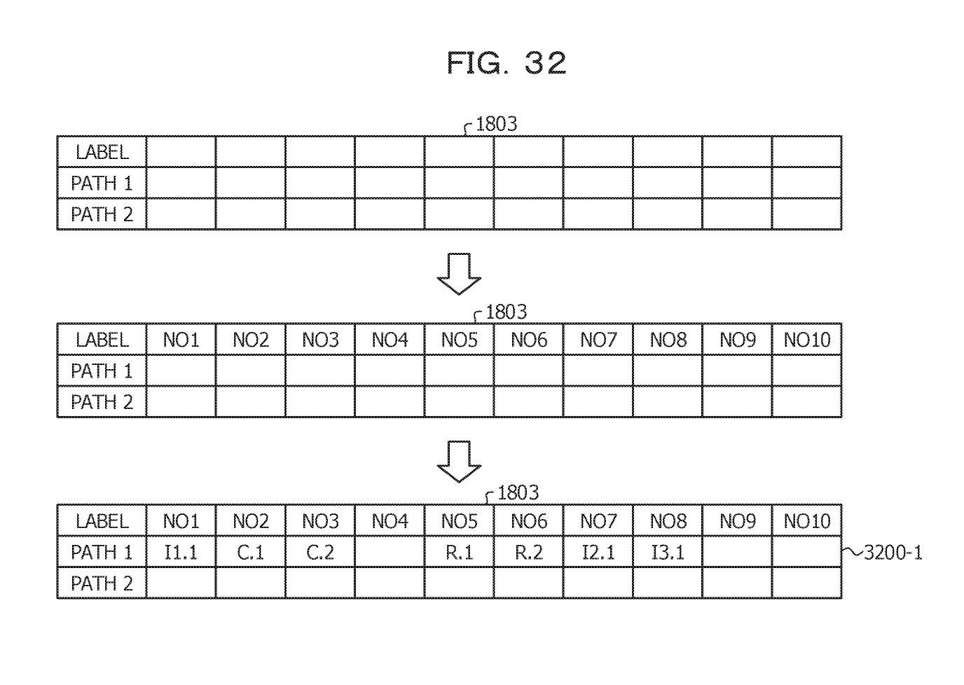

FIG. 32 is an explanatory diagram illustrating an example of the generation of the path definition data. For example, the second generator 1106 assigns the nodes defined in the node definition data 1902 to labels of the path definition data 1803. The assignment of the nodes to the labels is to set the names of the nodes to the labels of the path definition data 1803.

Next, the second generator 1106 associates, for each of the searched paths, component pins of components existing on the path with nodes, for example. Specifically, the second generator 1106 identifies a node associated with the component pin I1.1 based on the node definition data 1902. Since the node definition data 1902 illustrated in FIG. 31 defines that the node NO1 is associated with the pin of the component I1, the node that is associated with the component pin I1.1 of the component I1 is the node N01. The second generator 1106 associates the component pin I1.1 with a label corresponding to the node NO1 and included in the path definition data 1803. The results of the association are association data 3200-1.

A component pin C.1 of the component C is associated with the node NO2. A component pin C.2 of the component C is associated with the node NO3. A component pin R.1 of the component R is associated with the node N05. A component pin R.2 of the component R is associated with the node N06. The component pin I2.1 of the component I2 is associated with the node N07. The component pin I3.1 of the component I3 is associated with the node N08.

In the aforementioned manner, pins of components on each of the selected paths are associated with nodes.

Next, the second display unit 1107 illustrated in FIG. 11 displays the topology data 1801, association data 3200 generated for the searched paths, and the entry field for receiving restrictive data indicating restrictive requirements for the searched paths. The restrictive data is, for example, the line length data 1802.

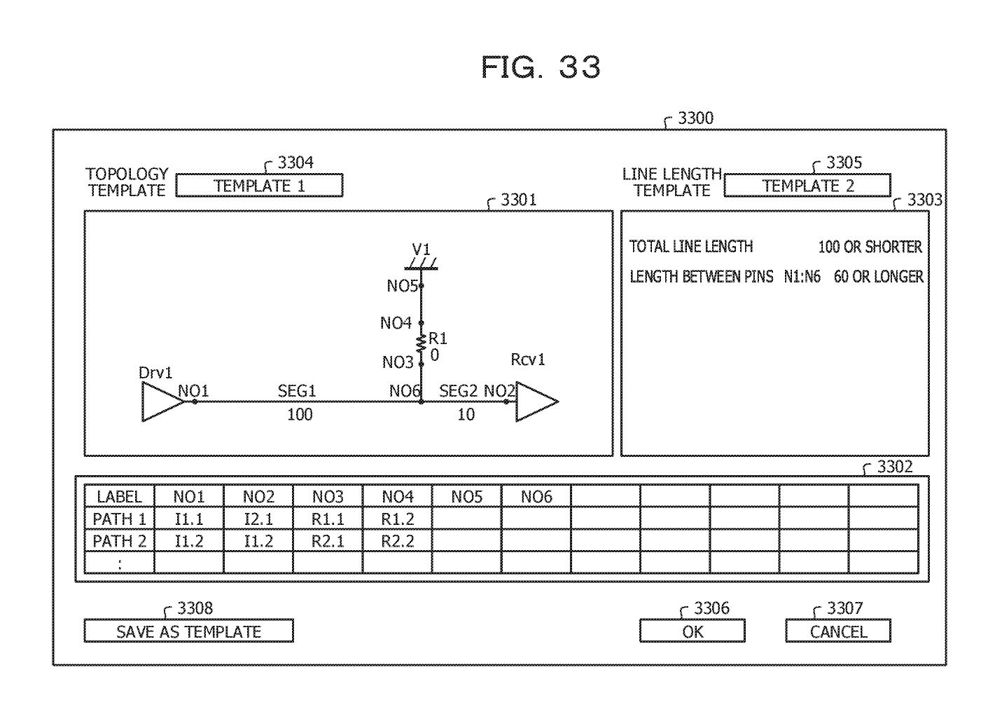

FIG. 33 is an explanatory diagram illustrating an example of the display. A screen 3300 includes a topology display field 3301, a field 3302 for displaying the path definition data 1803, a restrictive requirement reception field 3303, a topology template selection field 3304, and a line length template selection field 3305, for example. The screen 3300 includes an “OK” button 3306, a “cancel” button 3307, and a “save as template” button 3308.

The setting receiver 1108 receives the line length data 1802 entered by a designer's operation in the restrictive requirement reception field 3303.

The third generator 1109 causes received information to be stored as the line length data 1802 in the restrictive requirement table 1800. In this case, when the “OK” button 3306 is pressed by a designer's operation, the setting receiver 1108 causes the received information to be stored in the restrictive requirement table 1800.

The setting receiver 1108 receives selection of line length data 1802 by a user operation from among line length data 1802 included in template data displayed in the line length template selection field 3305. The third generator 1109 may cause the received line length data 1802 selected by the designer's operation to be stored in the restrictive requirement table 1800 as line length data 1802 for the displayed topology.

The setting receiver 1108 receives selection of template data by a designer's operation from among template data displayed in the topology template selection field 3304. Then, the third generator 1109 may cause the name of the template data selected by the designer's operation from among the template data displayed in the topology template selection field 3304 to be stored in the template name field of the restrictive requirement table 1800.

When the “save as template” button 3308 is pressed by a designer's operation, the third generator 1109 associates the topology data 1801 and the line length data 1802 with each other as template data and causes the topology data 1801 and the line length data 1802 to be stored. Thus, the line length data 1802 may be used as template data, and a restrictive requirement that is the same as a generated restrictive requirement may be efficiently set.

The setting receiver 1108 receives selection of line length data 1802 by a designer's operation from among the line length data 1802 stored as the template data displayed in the line length template selection field 3305.

The second display unit 1107 sets and displays, in the field 3303 for receiving restrictive requirements, a restrictive requirement indicated by the selected and received line length data 1802. Thus, the line length data 1802 may be used as template data, and a restrictive requirement that is similar to a generated restrictive requirement may be efficiently set.

In this manner, the circuit designer may set a restrictive requirement while looking at an image of a topology at a position at which the restrictive requirement is to be set on the screen.

By using the template data, a requirement that is similar to a generated restrictive requirement may be efficiently input.

### Flowchart of Example of Procedure for Circuit Design Support Process by Information Processing Device 100

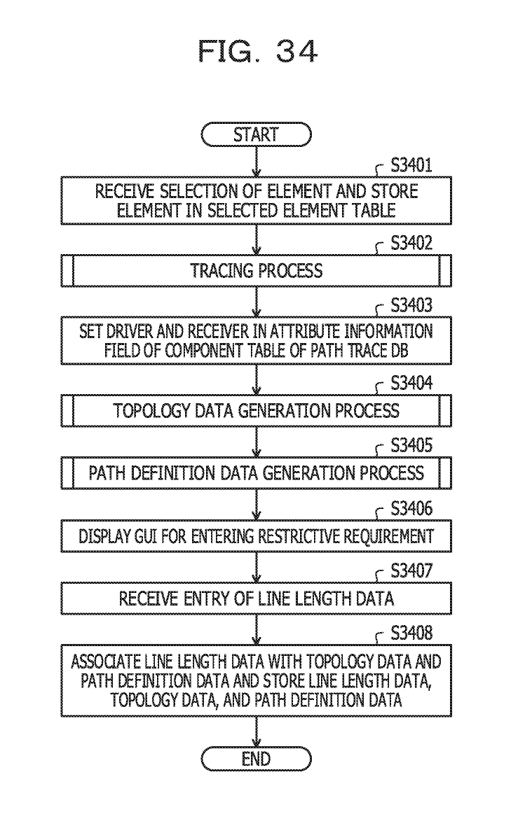

FIG. 34 is a flowchart of an example of a procedure for a circuit design support process by the information processing device. The information processing device 100 receives selection of an element and causes the selected element to be stored in the selected element table 2500 (in step S3401). Next, the information processing device 100 executes a tracing process (in step S3402). The information processing device 100 sets a driver and a receiver in an attribute information field of a component table 1201 stored in the path trace DB 2601 (in step S3403).

Next, the information processing device 100 executes a process of generating topology data 1801 (in step S3404). The information processing device 100 executes a process of generating path definition data 1803 (in step S3405). Then, the information processing device 100 displays a GUI for entering a restrictive requirement (in step S3406).

Then, the information processing device 100 receives entry of the line length data 1802 (in step S3407). The information processing device 100 associates the line length data 1802 with the topology data 1801 and the path definition data 1803, causes the line length data 1802, the topology data 1801, and the path definition data 1803 to be stored (in step S3408), and terminates the circuit design support process.

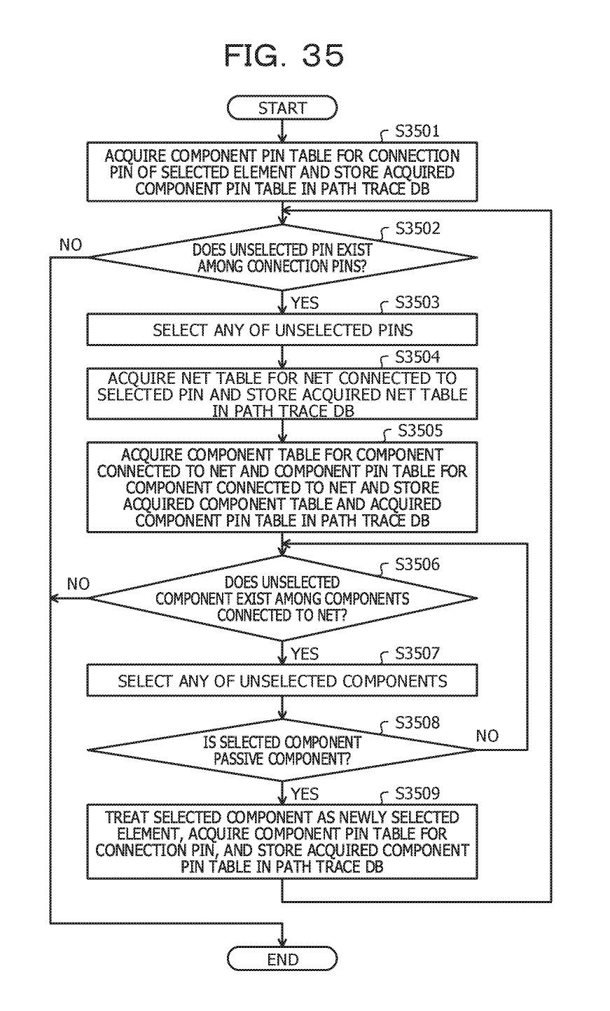

FIG. 35 is a flowchart describing the tracing process illustrated in FIG. 34 in detail. The information processing device 100 acquires a component pin table 1203 for a connection pin of the selected element from the circuit database 1112 and causes the acquired component pin table 1203 to be stored in the path trace DB 2601 (in step S3501). The selected element is an element registered in the selected element table 2500. The information processing device 100 determines whether or not an unselected pin exists among connection pins (in step S3502).

If the information processing device 100 determines that an unselected pin does not exist (No in step S3502), the information processing device 100 terminates the tracing process. If the information processing device 100 determines that an unselected pin exists (Yes in step S3502), the information processing device 100 selects any of unselected pins (in step S3503). The information processing device 100 acquires a net table 1202 for a net connected to the selected pin and causes the acquired net table 1202 to be stored in the path trace DB 2601 (in step S3504).

The information processing device 100 acquires a component table 1201 for a component connected to the net and a component pin table 1203 for the component connected to the net and causes the acquired component table 1201 and the acquired component pin table 1203 to be stored in the path trace DB 2601 (in step S3505). Then, the information processing device 100 determines whether or not an unselected component exists among components connected to the net (in S3506).

If the information processing device 100 determines that an unselected component does not exist (No in step S3506), the information processing device 100 terminates the tracing process. If the information processing device 100 determines that an unselected component exists (Yes in step S3506), the information processing device 100 selects any of unselected components (in step S3507).

Then, the information processing device 100 determines whether or not the selected component is a passive component (in step S3508). If the information processing device 100 determines that the selected component is not a passive component (No in step S3508), the information processing device 100 causes the process to return to step S3506. If the information processing device 100 determines that the selected component is a passive component (Yes in step S3508), the information processing device 100 treats the selected component as a newly selected element, acquires a component pin table 1203 for a connection pin of the selected component, causes the acquired component pin table 1203 to be stored in the path trace DB 2601 (in step S3509), and causes the process to return to step S3502.

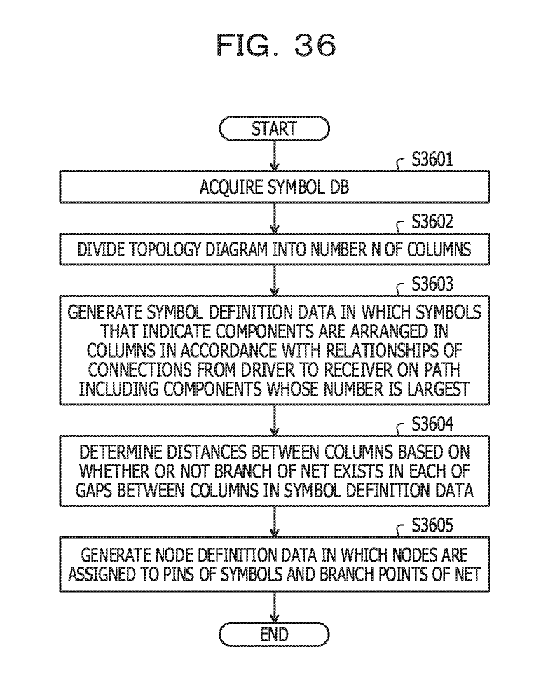

FIG. 36 is a flowchart describing, in detail, the topology data generation process illustrated in FIG. 34. The information processing device 100 acquires the symbol DB 1114 (in step S3601). Then, the information processing device 100 divides a topology diagram in a simulation space into a number N of columns (in step S3602).

The information processing device 100 generates symbol definition data 1901 in which symbols that indicate components are arranged in the columns, in accordance with relationships of connections from a driver to a receiver on a path including components whose number is the largest among paths indicated by the path trace DB 2601 (in step S3603). Then, the information processing device 100 determines distances between the columns in the symbol definition data 1901 based on whether a branch of the net exists in each of gaps between the columns (in step S3604).

Next, the information processing device 100 generates node definition data 1902 in which nodes are assigned to branch points of the net and pins of symbols arranged in the order from a pin of the driver to a pin of the receiver (in step S3605). Then, the information processing device 100 terminates the topology data generation process.

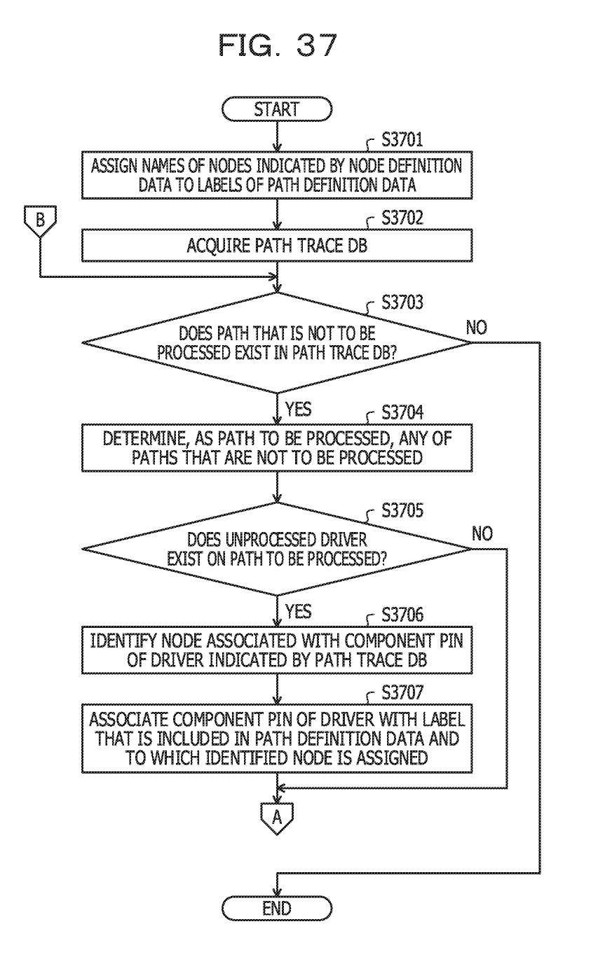

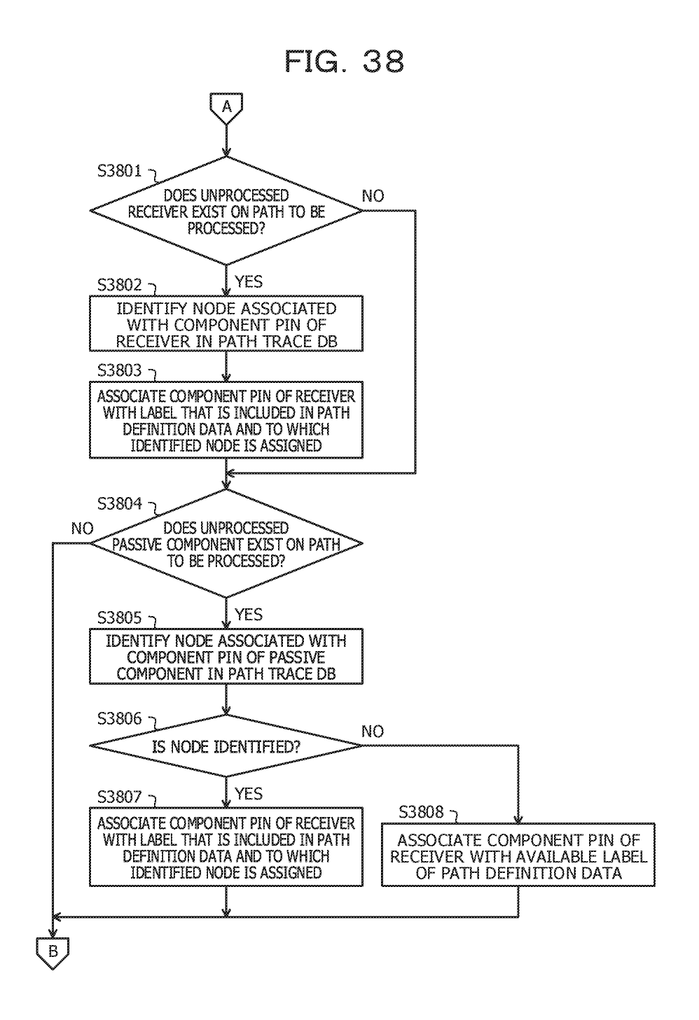

FIGS. 37 and 38 are flowcharts describing, in detail, the path definition data generation process illustrated in FIG. 34. The information processing device 100 assigns the names of the nodes indicated by the node definition data 1902 to labels of the path definition data 1803 (in step S3701).

Next, the information processing device 100 acquires the path trace DB 2601 (in step S3702). Then, the information processing device 100 determines whether or not a path that is not to be processed exists in the path trace DB 2601 (in step S3703). If the information processing device 100 determines that a path that is not to be processed exists (Yes in step S3703), the information processing device 100 determines, as a path to be processed, any of paths that are not to be processed (in step S3704).

Next, the information processing device 100 determines whether or not an unprocessed driver exists on the path to be processed (in step S3705). The unprocessed driver is a driver that is yet to be associated with a node. If the information processing device 100 determines that the unprocessed driver exists (Yes in S3705), the information processing device 100 identifies a node associated with a component pin of the driver within the path trace DB 2601 (in step S3706). In this case, the driver within the path trace DB 2601 is a driver whose component table 1201 is included in the path trace DB 2601.

Then, the information processing device 100 associates the component pin of the driver with a label that is included in the path definition data 1803 and to which the identified node is assigned (in step S3707), and the information processing device 100 causes the process to proceed to step S3801. If the information processing device 100 determines that the unprocessed driver does not exist (No in step S3705), the information processing device 100 causes the process to proceed to step S3801.

Next, the information processing device 100 determines whether or not an unprocessed receiver exists on the path to be processed (in step S3801). The unprocessed receiver is a receiver that is yet to be associated with a node. If the information processing device 100 determines that the unprocessed receiver does not exist (No in step S3801), the information processing device 100 causes the process to proceed to step S3804. If the information processing device 100 determines that the unprocessed receiver exists (Yes in step S3801), the information processing device 100 identifies a node associated with a component pin of the receiver within the path trace DB 2601 (in step S3802). The information processing device 100 associates the component pin of the receiver with a label that is included in the path definition data 1803 and to which the identified node is assigned (in step S3803).

The information processing device 100 determines whether or not an unprocessed passive component exists on the path to be processed (in step S3804). The unprocessed passive component is a passive component that is yet to be associated with a node. If the information processing device 100 determines that the unprocessed passive component does not exist (No in step S3804), the information processing device 100 causes the process to return to step S3703.

If the information processing device 100 determines that the unprocessed passive component exists (Yes in step S3804), the information processing device 100 identifies a node associated with a component pin of the passive component within the path trace DB 2601 (in step S3805). The information processing device 100 determines whether or not the information processing device 100 identified the node (in step S3806).

If the information processing device 100 determines that the information processing device 100 identified the node (Yes in step S3806), the information processing device 100 associates the component pin of the receiver with a label that is included in the path definition data 1803 and to which the identified node is assigned (in step S3807), and the information processing device 100 causes the process to return to step S3703. If the information processing device 100 determines that the information processing device 100 did not identify the node (No in step S3806), the information processing device 100 associates the component pin of the receiver with an available label of the path definition data 1803 (in step S3808) and causes the process to return to step S3703.

If the information processing device 100 determines that a path to be processed does not exist (No in step S3703), the information processing device 100 terminates the process.

As described above, the information processing device generates, for each of paths for which requirements are to be set, association information indicating association relationships between component pins on the path and nodes indicated by topology information and displays the association information, the topology information, and the requirement entry field. Thus, the circuit designer may set restrictive requirements while looking at a topology diagram on the screen.

In addition, the information processing device 100 receives restrictive data, associates the topology data, the association data, and the received restrictive data with each other, and causes the topology data, the association data, and the received restrictive data to be stored in the storage unit 1110. Thus, the circuit designer may associate restrictive requirements set by the circuit designer with a topology diagram and provide the restrictive requirements to the implementation designer. This may suppress the fact that the implementation designer sets a wiring based on a topology that is not intended by the circuit designer.

In addition, the information processing device 100 provides an instruction for a restrictive requirement based on a distance between two different nodes. For example, if a net that extends from a pin of a first component to a pin of a second component is branched and connected to a pin of a third component, a restrictive requirement for a net portion extending from the pin of the first component to the pin of the second component, and a restrictive requirement for a net portion extending from the pin of the first component to the pin of the third component, may be different and set. Thus, restrictive requirements may be set in detail.

In addition, a path that satisfies the predetermined requirement includes components whose number is the largest among searched paths.

In addition, the number of searched paths is two or more, driving components of the paths are the same, and at least receiving components of the paths among all the receiving components of the paths are the same. Thus, a topology for a path for which a restrictive requirement is to be set by a user may be generated.

In addition, an element is selected by a user operation. Thus, a topology for a path for which a restrictive requirement is to be set by a user may be generated.

In addition, the information processing device 100 sets, in restrictive data indicating restrictive requirements for wiring states of the searched paths, restrictive data selected by a user operation from among restrictive data stored in the storage unit 1110. Thus, a template may be used and a restrictive requirement that is the same as a generated restrictive requirement may be efficiently set.

In addition, the information processing device 100 sets, in the entry field for restrictive data, restrictive data that is among restrictive data stored in the storage unit 1110 and was selected by a user operation. Thus, a template may be used and edited, and a restrictive requirement that is similar to a generated restrictive requirement may be efficiently set.

The circuit design support method described in the embodiment may be achieved by causing a computer such as a personal computer or a workstation to execute the circuit design support program prepared in advance. The circuit design support program is stored in a computer-readable storage medium such as a magnetic disk, an optical disc, or a Universal Serial Bus (USB) flash memory. The circuit design support program is read by the computer from the storage medium and executed by the computer. The circuit design support program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a circuit design support program that causes a computer to execute a process comprising:
generating topology data indicating wiring states of components in a circuit to be designed based on circuit data indicating components included in the circuit and coupling relationships between the components, the topology data including at least one coupling line between each pair of nodes including at least one first node and at least one second node, each of the at least one first node corresponding to each of the components and each of the at least one second node corresponding to each of at least one branch point in a wiring of the circuit when the wiring includes the at least one branch point; and
displaying, in a display area, the generated topology data and an input field for receiving an input of restrictive data indicating restrictive requirements for each of the at least one coupling line between each of the nodes including the at least one first node and the at least one second node.

2. The non-transitory computer-readable storage medium according to claim 1, wherein the process further comprises:
searching at least one path that include at least one selected component or coupling line included in the wiring based on the circuit data; and
displaying, in the display area, the generated topology data of the searched path.

3. The non-transitory computer-readable storage medium according to claim 2, wherein the process further comprising:
generating, for the at least one path, association data indicating association relationships between the components included in the at least one path and nodes included in the at least one path.

4. The non-transitory computer-readable storage medium according to claim 3, wherein the process further comprises:
receiving the restrictive data entered in the displayed input field; and
associating the topology data, the association data, and the received restrictive data with each other and storing the topology data, the association data, and the received restrictive data in a storage unit able to be accessed by the computer.

5. The non-transitory computer-readable storage medium according to claim 1,
wherein the restrictive requirements are lengths between the different two nodes.

6. The non-transitory computer-readable storage medium according to claim 1,
wherein a plurality of paths is found in the searching; and
wherein the at least one path includes components whose number is the largest among the plurality of paths.

7. The non-transitory computer-readable storage medium according to claims 6,
wherein the at least one selected component or coupling line is two or more;
wherein the plurality of paths including a same driving component; and
wherein the plurality of paths including a same receiving component.

8. The non-transitory computer-readable storage medium according to claim 2,
wherein the at least one selected component or coupling line is selected from among components and coupling lines included in the wiring based on an operation executed on the computer.

9. The non-transitory computer-readable storage medium according to claim 4,
wherein restrictive data that indicates restrictive requirements for wiring states of paths different from the searched paths is stored in the storage unit; and
wherein the process further comprises:
setting, in the restrictive data indicating the restrictive requirements for the wiring states of the plurality of paths, restrictive data that is among the restrictive data stored in the storage unit and is selected based on an operation executed on the computer.

10. The non-transitory computer-readable storage medium according to claim 4,
wherein restrictive data that indicates restrictive requirements for wiring states of paths different from the searched paths is stored in the storage unit; and
wherein the process further comprises:
setting, in the displayed input field, restrictive data that is among the restrictive data stored in the storage unit and is selected based on an operation executed on the computer.

11. A circuit design support method comprising:
generating topology data indicating wiring states of components in a circuit to be designed based on circuit data indicating components included in the circuit and coupling relationships between the components, the topology data including at least one coupling line between each pair of nodes including at least one first node and at least one second node, each of the at least one first node corresponding to each of the components and each of the at least one second node corresponding to each of at least one branch point in a wiring of the circuit when the wiring includes the at least one branch point; and
displaying, in a display area, the generated topology data and an input field for receiving an input of restrictive data indicating restrictive requirements for each of the at least one coupling line between each of the nodes including the at least one first node and the at least one second node.

12. An information processing device comprising:
a memory; and
a processor configured to:
generate topology data indicating wiring states of components in a circuit to be designed based on circuit data indicating components included in the circuit and coupling relationships between the components, the topology data including at least one coupling line between each pair of nodes including at least one first node and at least one second node, each of the at least one first node corresponding to each of the components and each of the at least one second node corresponding to each of at least one branch point in a wiring of the circuit when the wiring includes the at least one branch point; and
display, in a display area, the generated topology data and an input field for receiving an input of restrictive data indicating restrictive requirements for each of the at least one coupling line between each of the nodes including the at least one first node and the at least one second node.
